(19) United States
(12) Patent Application Publication
(10) Pub. No.: US 2018/0089281 A1
(43) Pub. Date: Mar. 29, 2018

(54) SEMANTIC QUERY OVER DISTRIBUTED SEMANTIC DESCRIPTORS

(71) Applicant: CONVIDA WIRELESS, LLC, Wilmington, DE (US)

(72) Inventors: Xu Li, Plainsboro, NJ (US); Chonggang Wang, Princeton, NJ (US); Quang Ly, North Wales, PA (US); Dale N. Seed, Allentown, PA (US)

(21) Appl. No.: 15/720,197

(22) Filed: Sep. 29, 2017

Related U.S. Application Data
(60) Provisional application No. 62/401,640, filed on Sep. 29, 2016.

(51) Int. Cl. G06F 17/30

(52) U.S. Cl. CPC G06F 17/30545; G06F 17/30864

(57) ABSTRACT

Currently there is no existing solution for semantic query processing directly over distributed semantic descriptors (e.g., oneM2M <semanticDescriptor> resources). Discussed herein are multiple applications for semantic query over distributed semantic descriptors. In a first exemplary method, semantic query is considered when information is stored in a single semantic descriptor. In a second exemplary method, semantic query is considered when information that is requested or otherwise needed is not stored in semantic descriptors. In a third exemplary method, semantic query is considered when information is distributed in different but related semantic descriptors. In a fourth exemplary method, semantic query is considered when information is distributed in different and unrelated or peer semantic descriptors. In a fifth method, there may be indirect querying of information from targeted resources by leveraging existing semantic resource discovery mechanisms.

### CROSS-REFERENCE TO RELATED APPLICATIONS

This application claims the benefit of U.S. Provisional Patent Application No. 62/401,640, filed on Sep. 29, 2016, entitled “Semantic Query Processing Over Distributed Semantic Descriptors,” the contents of which are hereby incorporated by reference herein.

### BACKGROUND

Semantic Web

The Semantic Web is an extension of the Web through standards by the World Wide Web Consortium (W3C). The standards promote common data formats and exchange protocols on the Web, most fundamentally the Resource Description Framework (RDF).

The Semantic Web involves publishing in languages specifically designed for data: Resource Description Framework (RDF), Web Ontology Language (OWL), and Extensible Markup Language (XML). These technologies are combined to provide descriptions that supplement or replace the content of Web documents via web of linked data. Thus, content may manifest itself as descriptive data stored in Web-accessible databases, or as markup within documents, particularly, in Extensible HTML (XHTML) interspersed with XML, or, more often, purely in XML, with layout or rendering cues stored separately.

Semantic Web Stack

The Semantic Web Stack illustrates the architecture of the Semantic Web specified by W3C, as shown in FIG. 1. The functions and relationships of the components, as shown in FIG. 1, are discussed below. XML provides an elemental syntax for content structure within documents, yet associates no semantics with the meaning of the content contained within. XML is not at present a necessary component of Semantic Web technologies in most cases, as alternative syntaxes exist, such as Turtle. Turtle is the de facto standard but has not been through a formal standardization process. XML Schema is a language for providing and restricting the structure and content of elements contained within XML documents. RDF is a simple language for expressing data models, which refers to objects (“web resources”) and their relationships in the form of subject-predicate-object, e.g., S-P-O triple or RDF triple. An RDF-based model can be represented in a variety of syntaxes, e.g., RDF/XML, N3, Turtle, and RDFa. RDF is a fundamental standard of the Semantic Web.

RDF Graph is a directed graph where the edges represent the “predicate” of RDF triples while the graph nodes represent “subject” and/or “object” of RDF triples. In other words, the linking structure as described in RDF triples forms a directed RDF Graph. RDF Schema (e.g., RDF Schema 1.1.) extends RDF and is a vocabulary for describing properties and classes of RDF-based resources, with semantics for generalized-hierarchies of such properties and classes. OWL adds more vocabulary for describing properties and classes: among others, relations between classes (e.g. disjointness), cardinality (e.g. “exactly one”), equality, richer type of properties, characteristics of properties (e.g. symmetry), and enumerated classes.

SPARQL (e.g., SPARQL 1.1) is a protocol and query language for semantic web data sources, to query and manipulate RDF graph content (e.g., RDF triples) on the Web or in an RDF store (e.g., a Semantic Graph Store). SPARQL 1.1 Query (a query language for RDF graph) can be used to express queries across diverse data sources, whether the data is stored natively as RDF or viewed as RDF via middleware. SPARQL contains capabilities for querying required and optional graph patterns along with their conjunctions and disjunctions. SPARQL also supports aggregation, subqueries, negation, creating values by expressions, extensible value testing, and constraining queries by source RDF graph. The results of SPARQL queries can be result sets or RDF graphs. SPARQL 1.1 Update is an update language for RDF graphs. It uses a syntax derived from the SPARQL Query Language for RDF. Update operations are performed on a collection of graphs in a Semantic Graph Store. Operations are provided to update, create, and remove RDF graphs in a Semantic Graph Store. RIF is the W3C Rule Interchange Format. It's an XML language for expressing Web rules that computers can execute. RIF provides multiple versions, called dialects. It includes a RIF Basic Logic Dialect (RIF-BLD) and RIF Production Rules Dialect (RIF PRD).

Semantic Search and Semantic Query

Relational Databases contain relationships between data in an implicit manner. For example the relationships between customers and products (stored in two content-tables and connected with an additional link-table) only come into existence in a query statement (e.g., SQL is used in the case of relational databases) written by a developer. Writing the query demands the exact knowledge of the database schema. Many relational databases are modeled as in a hierarchical database in which the data is organized into a tree-like structure. The data is stored as records which are connected to one another through links. A record in the hierarchical database model corresponds to a row (or tuple) in the relational database model and an entity type corresponds to a table (or relation—parent & child). A search or query of a record may be conducted by SQL or non-SQL search engines.

As shown in FIG. 2, a hierarchical database model mandates that each child record has only one parent, whereas each parent record can have one or more child records. In order to retrieve data from a hierarchical database the whole tree needs to be traversed starting from the root node. This structure is simple but inflexible because the relationship is confined to a one-to-many relationship.

Linked-Data contain all relationships between data in an explicit manner. In the above mentioned example described for relational database, no query code needs to be written. The correct product for each customer can be fetched automatically. Whereas this simple example is trivial, the real power of linked-data comes into play when a network of information is created (customers with their geo-spatial information like city, state and country; products with their categories within sub- and super-categories). Now the system can automatically answer more complex queries and analytics that look for the connection of a particular location with a product category. The development effort for this query is omitted. Executing a semantic query is conducted by walking the network of information and finding matches (also called data graph traversal).

Semantic Search seeks to improve search accuracy by understanding searcher intent and the contextual meaning of terms as they appear in the searchable dataspace, whether on the Web or within a closed system, to generate more relevant results. Semantic search systems consider various points including context of search, location, intent, variation of words, synonyms, generalized and specialized queries, concept matching, and natural language queries to provide relevant search results. Major web search engines like Google and Bing incorporate some elements of Semantic Search. Semantic Search uses semantics to produce highly relevant search results. In most cases, the goal is to deliver the information queried by a user rather than have a user sort through a list of loosely related keyword results. For example, semantics may be used to enhance a record search or query in a hierarchical relational database.

Semantic query allows for queries and analytics of associative and contextual nature. Semantic queries enable the retrieval of both explicitly and implicitly derived information based on syntactic, semantic and structural information contained in data. They are designed to deliver precise results (possibly the distinctive selection of one single piece of information) or to answer more fuzzy and wide open questions through pattern matching and digital reasoning.

Semantic queries work on named graphs, linked-data, or triples. This enables the query to process the actual relationships between information and infer the answers from the network of data. This is in contrast to semantic search, which uses semantics in unstructured text to produce a better search result (e.g., natural language processing).

From a technical point of view semantic queries are precise relational-type operations much like a database query. They work on structured data and therefore have the possibility to utilize comprehensive features like operators (e.g. >, <, and =), namespaces, pattern matching, sub-classing, transitive relations, semantic rules, and contextual full text search. The semantic web technology stack of W3C offers SPARQL to formulate semantic queries in syntax similar to SQL. Semantic queries are used in triple stores, graph databases, semantic wikis, natural language, and artificial intelligence systems.

Another aspect of semantic queries is that the type of the relationship can be used to incorporate intelligence into the system. The relationship between a customer and a product has a fundamentally different nature than the relationship between a neighborhood and its city. The latter enables the semantic query engine to infer that a customer living in Manhattan is also living in New York City whereas other relationships might have more complicated patterns and “contextual analytics.” This process is called inference or reasoning and is the ability of the software to derive new information based on given facts.

oneM2M Functional Architecture

The oneM2M standard (neM2M-TS-0001 oneM2M Functional Architecture-V2.9.0) under development defines a Service Layer called common service entity (CSE). The purpose of the service layer is to provide “horizontal” services that can be utilized by different “vertical” M2M systems and applications. The CSE supports the reference points as shown in FIG. 3. The Mca reference point interfaces with the Application Entity (AE). The Mcc reference point interfaces with another CSE within the same service provider domain and the Mcc′ reference point interfaces with another CSE in a different service provider domain. The Mcn reference point interfaces with the underlying network service entity (NSE). An NSE provides underlying network services to the CSEs, such as device management, location services, and device triggering.

CSE contains multiple logical functions called common service functions (CSFs), such as “Discovery” and “Data Management & Repository.” FIG. 4 illustrates some of the CSFs defined by oneM2M.

The oneM2M architecture enables the types of nodes as shown in FIG. 3. An applications service node (ASN) is a Node that contains one CSE and contains at least one application entity (AE). An ASN may reside in an M2M end device. An application dedicated node (ADN) is a node that contains at least one AE and does not contain a CSE. There may be zero or more ADNs in the Field Domain of the oneM2M System. Example of physical mapping: an Application Dedicated Node could reside in a constrained M2M Device. A middle node (MN) is a Node that contains one CSE and contains zero or more AEs. There may be zero or more MNs in the Field Domain of the oneM2M System. A MN may reside in an M2M Gateway. A infrastructure node (IN) is a node that contains one CSE and contains zero or more AEs. There is exactly one IN in the Infrastructure domain per oneM2M Service Provider. A CSE in an IN may contain CSE functions not applicable to other node types. Example of physical mapping: an IN could reside in an M2M Service Infrastructure. A non-oneM2M node (NoDN) is a node that does not contain oneM2M Entities (neither AEs nor CSEs). Such nodes represent devices attached to the oneM2M system for interworking purposes, including management.

Semantic Enablement in oneM2M

The <semanticDescriptor> resource as shown in FIG. 5 is used to store a semantic description pertaining to a resource and potentially sub-resources. Such a description may be provided according to ontologies. The semantic information is used by the semantic functionalities of the oneM2M system and is also available to applications or CSEs. The <semanticDescriptor> resource shall contain the attributes specified in Table 1.

TABLE 1
Attributes of <semanticDescriptor> Resource

| | | RW/ | |
|---|---|---|---|
| Attributes of | | RO/ | |
| <semanticDescriptor> | Multiplicity | WO | Description |
| descriptorRepresentation | 1 | RW | Indicates the type used for the serialization |
| | | | of the descriptor attribute, e.g. RDF |
| | | | serialized in XML. |
| semanticOpExec | 0 . . . 1 | RW | This attribute cannot be retrieved. Contains |
| | | | a SPARQL query request for execution of |
| | | | semantic operations on the descriptor |
| | | | attribute e.g. SPARQL update as described |
| | | | in oneM2M TS-0004. |
| descriptor | 1 | RW | Stores a semantic description pertaining to |
| | | | a resource and potentially sub-resources. |
| | | | Such a description shall be according to |
| | | | subject-predicate-object triples as defined |
| | | | in the RDF graph-based data model (see |
| | | | W3C RDF 1.1). The semantic description |
| | | | can be fully and partially updated by an |
| | | | Originator. The elements of such triples |
| | | | may be provided according to ontologies. |
| | | | Examples of such descriptors in RDF can |
| | | | be found in oneM2M TR-0007. |
| ontologyRef | 0 . . . 1 | WO | A reference (Uniform Resource Identifier - |
| | | | URI) of the ontology used to represent the |
| | | | information that is stored in the descriptor |
| | | | attribute. If this attribute is not present, the |
| | | | ontologyRef from the parent resource is |
| | | | used if present. |
| relatedSemantics | 0 . . . 1 (L) | WO | List of URIs for resources containing |
| | | | related semantic information to be used in |
| | | | processing semantic queries. The URI(s) |
| | | | may reference either a <group> resource or |
| | | | other <semanticDescriptor> resources. |

Semantic Filtering Proposals in oneM2M

Generic filtering is supported by having filter criteria specified in a request operation (oneM2M-TS-0001 oneM2M Functional Architecture-V2.9.0 section 8.1.2). In order to provide for semantic filtering, an additional value for the request operation filter criteria has been proposed in oneM2M TR-0007-Study_on_Abstraction_and_Semantics_Enablement-V2.11.0 section 8.5.4, with the definition shown in the table below. Multiple instances may be used, which according to the general rules for evaluating filter criteria, means that an “OR” semantics applies, e.g. the overall result for the semantics filter criteria is true if one or more of the semantic filters matches the semantic description. Note that semantics in the table below is defined in neM2M TR-0007-Study_on_Abstraction_and_Semantics_Enablement-V2.11.0 and it corresponds to request parameter semanticFilter in oneM2M-TS-0001 oneM2M Functional Architecture-V2.9.0. When the SPAQRL query contained in the semanticFilter parameter matches semantic triples in one of child resource <semanticDescriptor>s of a parent resource, it means this semantic filtering is successful and corresponding parent resource will be returned.

TABLE 2
semantics Filter Criteria

| | | |
|---|---|---|
| semantics | 0 . . . n | The semantic description contained in one of the |
| | | <semanticDescriptor> child resources matches the |
| | | specified semantic filter. |

The proposal above uses the following assumptions: the semantic descriptions are specified as RDF triples (representation, e.g. RDF/XML, Turtle, description format had not been fully specified in oneM2M yet); the semantics filter criteria will be used for SPARQL requests to be executed on semantic descriptions.

Below is a semantic filtering example giving in oneM2M TR-0007.

### Example 1: Filter for AE Resources Representing Devices that Measure Temperature

### Semantic Descriptor of Device 1 AE

| | | |
|---|---|---|
| my:MyDevice1 | rdf:type | base:Device |
| my:MyDevice1 | base:hasService | my:MyService1 |
| my:MyService1 | base:hasFunctionality | my:MyFunctionality1 |
| my:MyFunctionality1 | rdf:type | base:Measuring |
| my:MyFunctionality1 | base:refersTo | my:MyAspect1 |
| my:myAspect1 | rdf:type | aspect:Temperature |

### Semantic Descriptor of Device 2 AE

| | | |
|---|---|---|
| my:MyDevice2 | rdf:type | base:Device |
| my:MyDevice2 | base:hasService | my:MyService2 |
| my:MyService2 | base:hasFunctionality | my:myFunctionality2 |
| my:myFunctionality2 | rdf:type | base:Controlling |
| my:myFunctionality2 | base:refersTo | my:myAspect2 |
| my:myAspect2 | rdf:type | aspect:Temperature |

### SPARQL Request 1

```
SELECT ?device
    WHERE { ?device rdf:type base:Device .
        ?device base:hasService ?service .
        ?service base:hasFunctionality ?functionality.
        ?functionality rdf:type base:Measuring .
        ?functionality base:refersTo ?aspect .
        ?aspect rdf:type instance:Temperature }
```

### SPARQL Execution Results

(On Device1 semantic description)-->my:myDevice1
(On Device 2 semantic description)-->empty

This means that the AE resource that is described by my:myDevice1 will be included in the result set, whereas the AE resource described by my:myDevice2 will not be included.

In some cases the relevant semantic information for a single search may be distributed among different <semanticDescriptor> resources. The example provided in FIG. 6 illustrates this case. The box represents the scope of a semantic filter, e.g., this is the information required for evaluating it. The semantic graph representing subject-predicate-object relations is shown, with different parts of this graph (represented by ovals) being stored in different <semanticDescriptor> resources. Semantic filtering needs to be applied to (parts of) the complete semantic graph, which raises the problem that several different parts of the graph have to be put together for the execution of the semantic operation.

This problem is not generally apparent in the realm of the Semantic Web, since the URI identifying class instances can be directly de-referenced so the concept (e.g. class, relationship) information can be found based on its URI. In the oneM2M case, only resources that can be accessed and semantics are stored as resource content.

Currently SPARQL 1.1, supports federated queries using the SERVICE keyword, where the URL of a remote SPARQL endpoint can be specified. For this approach, a requestor would a-priori know which semantic descriptors contain the semantic instances required for the search, making this approach not generally applicable when the semantic descriptors are distributed in resource trees.

A solution for enabling semantic filtering on semantic descriptions stored across <semanticDescriptor> resources presented in introduces an annotation link in the form of a resourceDescriptorLink OWL annotation property. This annotation property can be specified for any class instance and its value is the URL of a <semanticDescriptor> resource, where additional RDF triples for the given class instance can be found. The following example uses the classes and relationships defined in the oneM2M Base Ontology (FIG. 7) in order to create the graphs in FIG. 8.

This solution entails the following functional flow for the SPARQL-based semantic filtering engine at the receiver:
The semantic filter formulated as a SPARQL request is executed on the content of the semantic descriptor resource of the candidate resource
If in the course of the execution a class instance with one or more resourceDescriptorLink annotations is encountered, the execution is halted
The content of each of the <semanticDescriptor> resources the resourceDescriptorLink references is added to the content on which the SPARQL request is being executed
The execution of the SPARQL request is continued on the enlarged content Semantic Filtering/Discovery and Semantic Query in oneM2M Context

oneM2M supports semantic resource discovery through semantic filter. In general, semantic queries allow for queries and analytics of associative and contextual nature. Semantic queries enable the retrieval of both explicitly and implicitly derived information based on syntactic, semantic, or structural information contained in data.

Below is a summary of the differences between semantic query and semantic resource discovery. Semantic Query is to extract useful knowledge over RDF data infrastructure. Semantic resource discovery is targeted for discovering resources and return resource URIs based on resource's semantic metadata or semantic filter (Note that semantic query can also return resource URIs, e.g. semantic query can do more than semantic resource discovery). FIG. 9 shows the examples of query results of various semantic queries. As an example shown in FIG. 9, the Query 3 is querying for homepages and the return results of this query is a set of resource URIs (e.g., homepage addresses). Semantic query is associated more with semantic-centric infrastructure such as Triple Store while semantic resource discovery is associated more with resource tree infrastructure, such as oneM2M resource tree defined in the service layer. Semantic query can return any format of query results in term of “knowledge”, not just URIs of resources.

### SUMMARY

Semantic queries enable the retrieval of both explicitly and implicitly derived information/knowledge based on syntactic, semantic, and structural information contained in data (e.g., in terms of RDF triples). Currently, in oneM2M context, there are mainly two architecture choices for supporting semantic related features, e.g., one is the centralized approach, in which there is a centralized Triple Store in the system such that semantic processing, e.g., semantic query, will be executed over the centralized Triple Store. The other one is the distributed approach in the sense that the triples are dispersed in the resource tree and stored in different <semanticDescriptor> resources.

Currently there is no existing solution for semantic query processing directly over distributed semantic descriptors (e.g. oneM2M <semanticDescriptor> resources). Discussed herein are multiple applications for semantic query over distributed semantic descriptors. In a first exemplary method, semantic query is considered when information is stored in a single semantic descriptor. In a second exemplary method, semantic query is considered when information that is requested or otherwise needed is not stored in semantic descriptors. In a third exemplary method, semantic query is considered when information is distributed in different but related semantic descriptors. In a fourth exemplary method, semantic query is considered when information is distributed in different and unrelated or peer semantic descriptors. In a fifth method, there may be indirect querying of information from targeted resources by leveraging existing semantic resource discovery mechanisms.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates an Architecture of the Semantic Web;

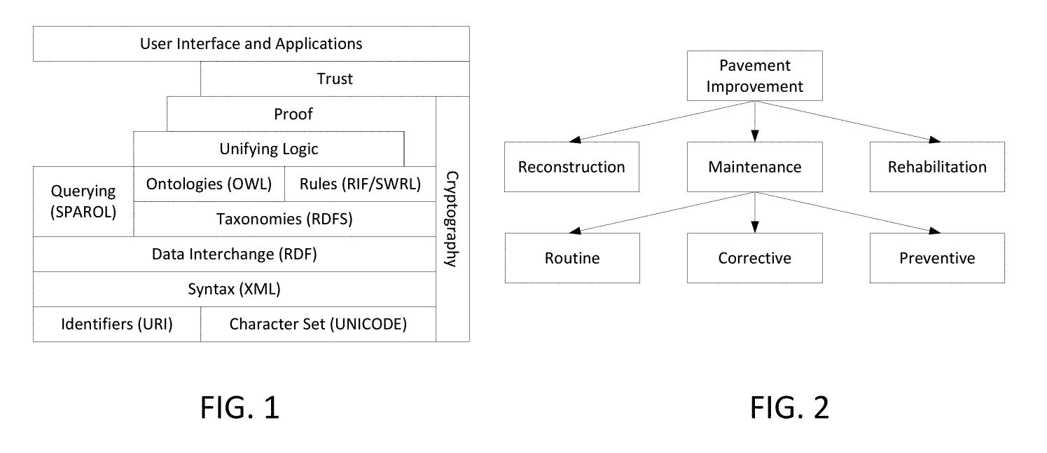

FIG. 2 illustrates an exemplary Hierarchical Database;

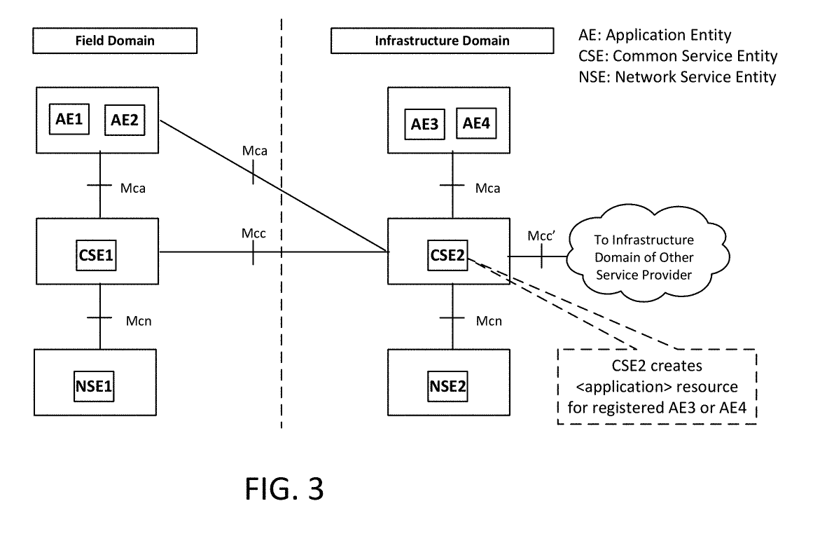

FIG. 3 illustrates oneM2M Architecture;

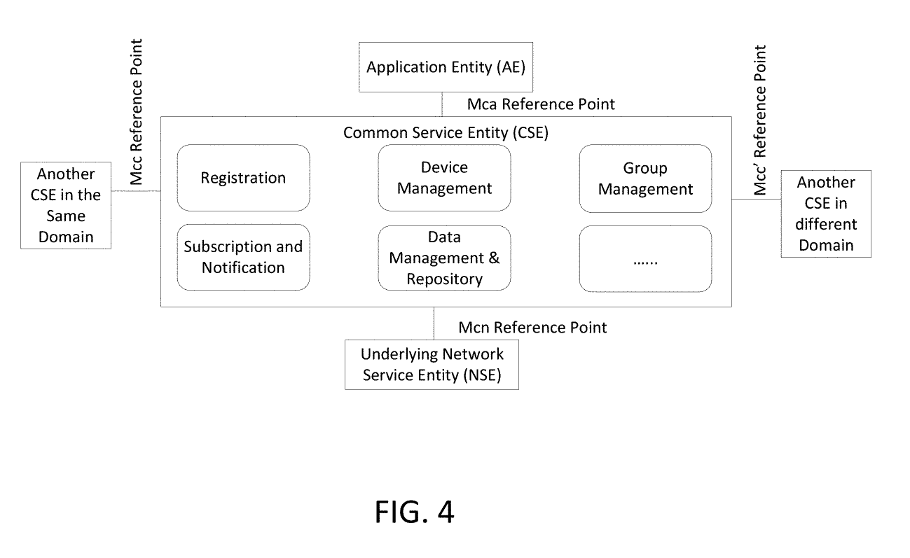

FIG. 4 illustrates oneM2M Common Service Functions;

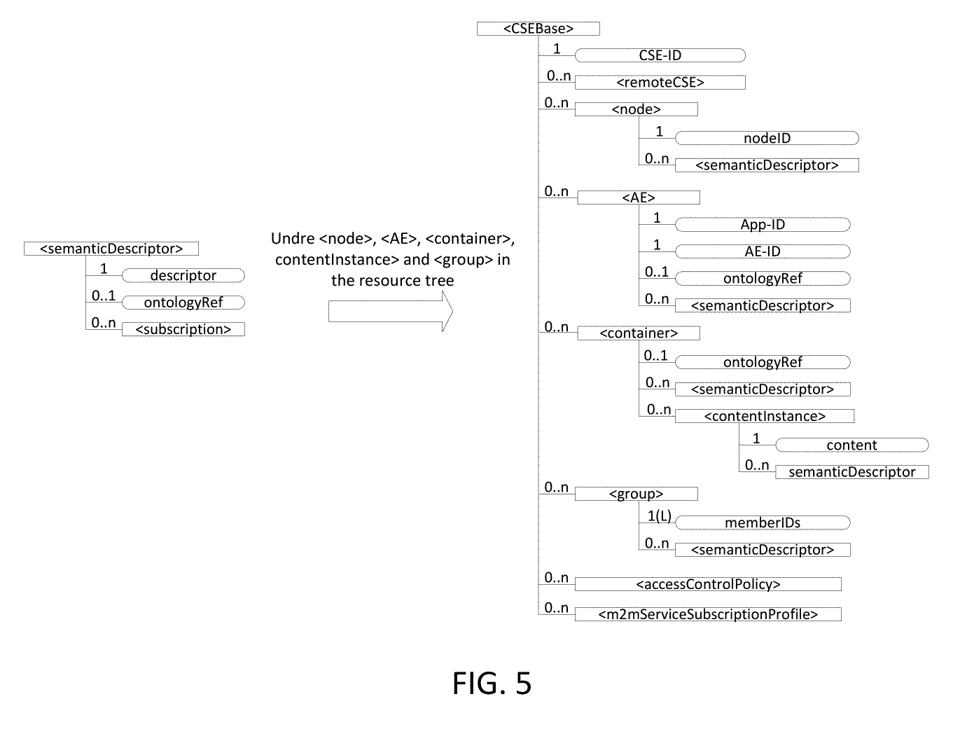

FIG. 5 illustrates a Structure of <semanticDescriptor> Resource in a Resource Tree;

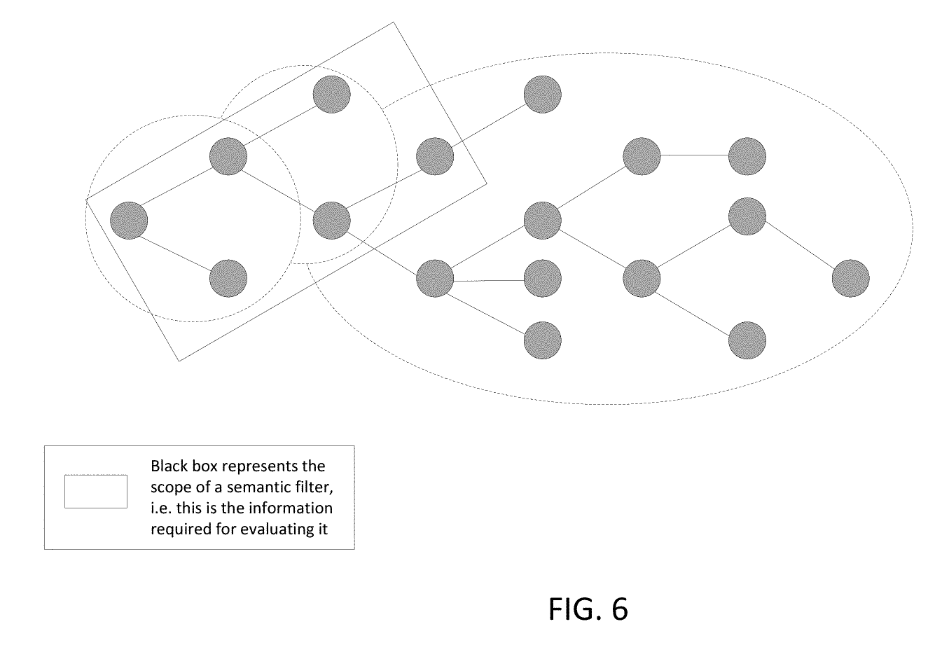

FIG. 6 illustrates an example Scope of semantic filter across semantic information stored in different resources;

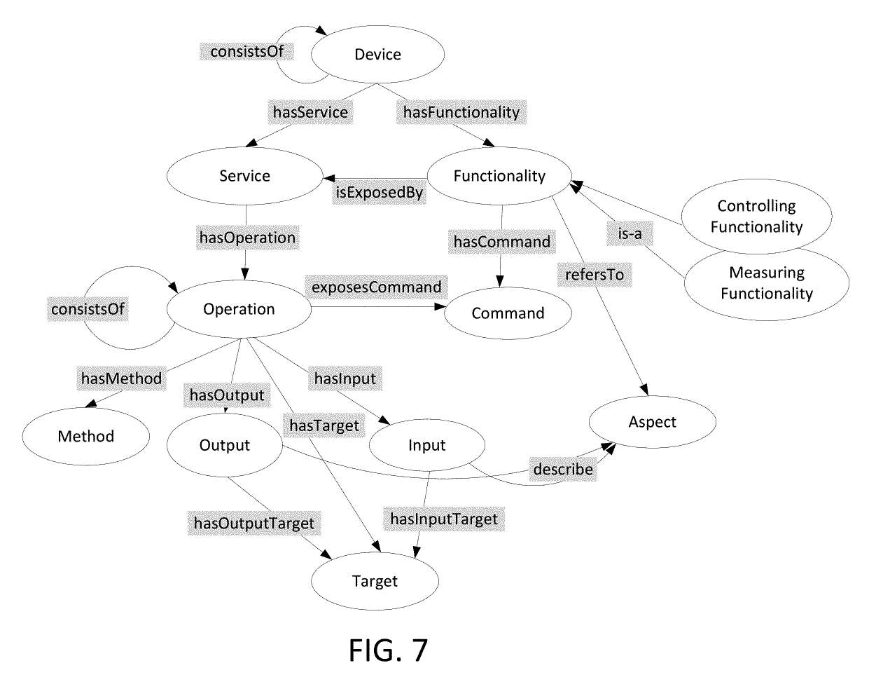

FIG. 7 illustrates an exemplary oneM2M Base Ontology;

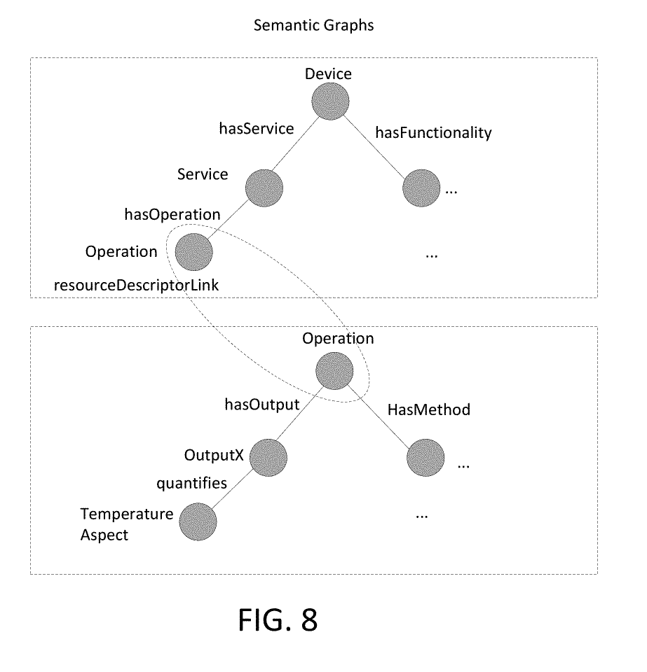

FIG. 8 illustrates an exemplary resourceDescriptionLink;

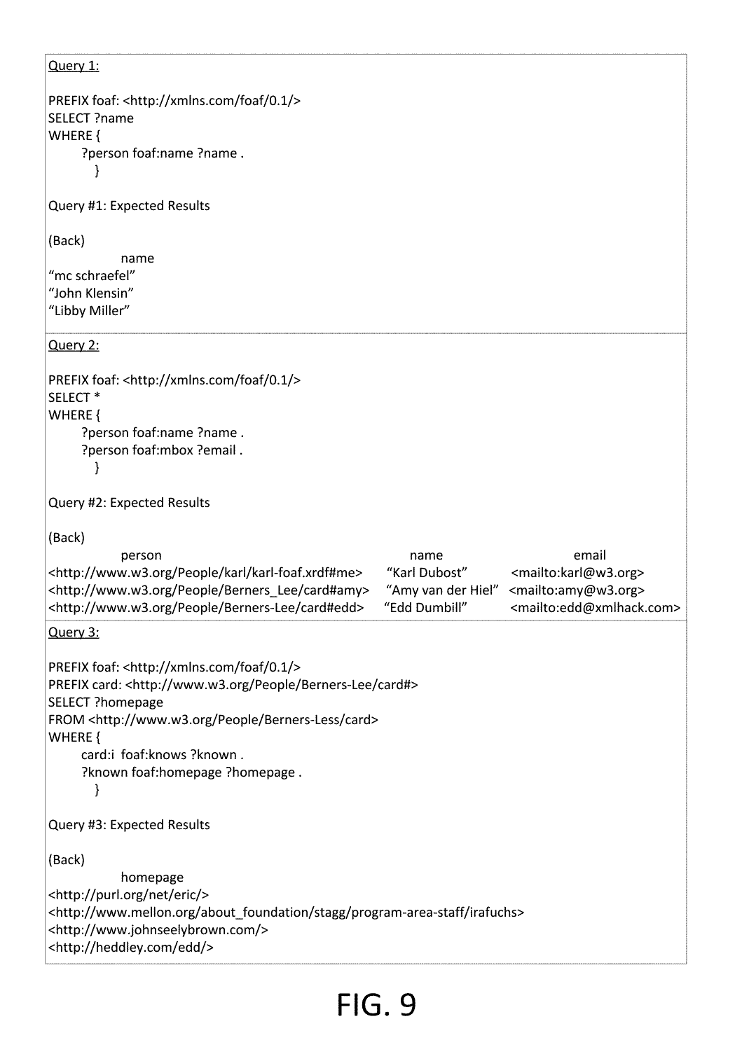

FIG. 9 illustrates exemplary query results of semantic queries provided by world wide web consortium;

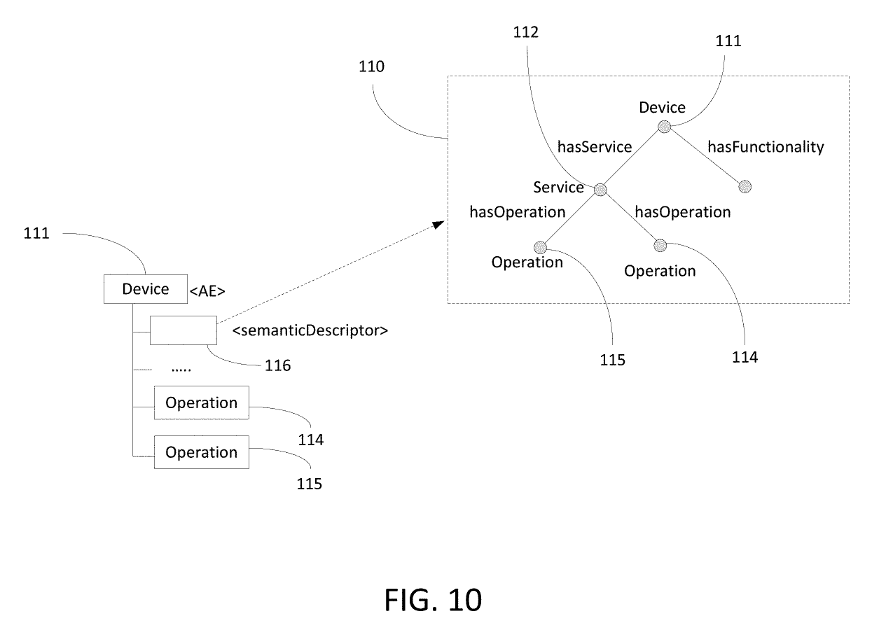

FIG. 10 illustrates Access Control in a Hierarchically Layered Structure—Controlled by the Semantic Layer;

FIG. 11 illustrates Procedure for Semantic Query Processing for first scenario;

FIG. 12 illustrates Semantic Query Requiring Information Not Stored in <semanticDescriptor> Resources;

FIG. 13 illustrates Option 1 for How to Create/Store RDF Triples for New Information for scenario 2A;

FIG. 14 illustrates information clone procedure for option 1 of scenario 2A;

FIG. 15 illustrates Semantic Query Processing Procedure for Option 1 of scenario 2A;

FIG. 16 illustrates Alternative Semantic Query Processing Procedure for Option 1 of scenario 2A Based on On-Demand Information Cloning;

FIG. 17 illustrates Option 2 for How to Create/Store RDF Triples for New Information of scenario 2A;

FIG. 18 illustrates Information Clone Procedure for Option 2 of scenario 2A;

FIG. 19 illustrates scenario 2B;

FIG. 20 illustrates Information Linking Procedure for scenario 2B;

FIG. 21 illustrates Semantic Query Processing Procedure scenario 2B;

FIG. 22 illustrates exemplary scenario for Semantic Query Requiring Information Distributed in Different but Related <semanticDescriptor> Resources;

FIG. 23 illustrates third scenario;

FIG. 24 illustrates Semantic Query Processing Procedure for the third scenario;

FIG. 25 illustrates Semantic Query Requiring Information Distributed in Different and Unrelated <semanticDescriptor> Resources;

FIG. 26 illustrates Involved Resource for Semantic Query Processing for Scenario 4;

FIG. 27 illustrates Semantic Query Processing Procedure for Basis Solution of scenario 4;

FIG. 28 illustrates Different Query Scopes;

FIG. 29 illustrates Semantic Query Processing Procedure for Approach 1 of Enhanced Solution of scenario 4;

FIG. 30 illustrates Operating Details of Approach 2 in Solution B for scenario 4;

FIG. 31 illustrates Semantic Query Processing Procedure for Approach 2 of Enhanced Solution of scenario 4;

FIG. 32 illustrates Indirect Querying Information from Targeted Resources by Leveraging Existing Semantic Resource Discovery;

FIG. 33 illustrates Semantic Query Processing Procedure for scenario 5A;

FIG. 34 illustrates Semantic Query Processing Procedure for t scenario 5B;

FIG. 35 illustrates DAS CSF for oneM2M Service Layer;

FIG. 36 illustrates <QueryPortal> Resource;

FIG. 37 illustrates oneM2M-centric Procedure for Semantic Query Processing for scenario 4 through <queryPortal> resource;

FIG. 38 illustrates exemplary user interface for semantic query scope checker;

FIG. 39 illustrates exemplary user interface for semantic query launcher;

FIG. 40 illustrates exemplary user interface for semantic query result display;

FIG. 41A illustrates an exemplary machine-to-machine (M2M) or Internet of Things (IoT) communication system in which the disclosed subject matter may be implemented;

FIG. 41B illustrates an exemplary architecture that may be used within the M2M/IoT communications system illustrated in FIG. 41A;

FIG. 41C illustrates an exemplary M2M/IoT terminal or gateway device that may be used within the communications system illustrated in FIG. 41A; and

FIG. 41D illustrates an exemplary computing system in which aspects of the communication system of FIG. 41A may be embodied.

### DETAILED DESCRIPTION OF ILLUSTRATIVE EXAMPLES

Currently, in oneM2M context, there are mainly two architecture choices for supporting semantic related features, e.g., one is the centralized approach, in which there is a centralized Triple Store in the system such that semantic processing, e.g., semantic query, will be executed over the Triple Store. In other words, there is a centralized triple store and the RDF triples are stored in this triple store for supporting most of semantic processing. The other one is the distributed approach in the sense that the triples are dispersed in the resource tree and stored in different <semanticDescriptor> resources. Those <semanticDescriptor> resources are often the child resources of normal oneM2M resources, and they mainly serve for semantic annotation purposes and can further enable semantic resource discovery. In particular, in this distributed approach, each CSE needs to gather information from different <semanticDescriptor> resources and form a local/temporal Triple Store in order to conduct semantic processing on it.

There are multiple scenarios that may give context to the disclosed methods and systems for semantic query over distributed semantic descriptors. Some of the scenarios include the following: 1) the information only from a single <semanticDescriptor> resource; 2) semantic query requires information that is not stored in the <semanticDescriptor> resource; 3) semantic query requires information that may be stored in distributed, but different <semanticDescriptor> resources; 4) Semantic Query Requiring Information Distributed in Different and Unrelated <semanticDescriptor> Resources; or 5) indirect querying of information from targeted resources by leveraging existing semantic resource discovery. Discussed below are methods, systems, and apparatuses that may be used for distributed semantic query, such as in the aforementioned scenarios. The scenarios will be discussed in more detail below.

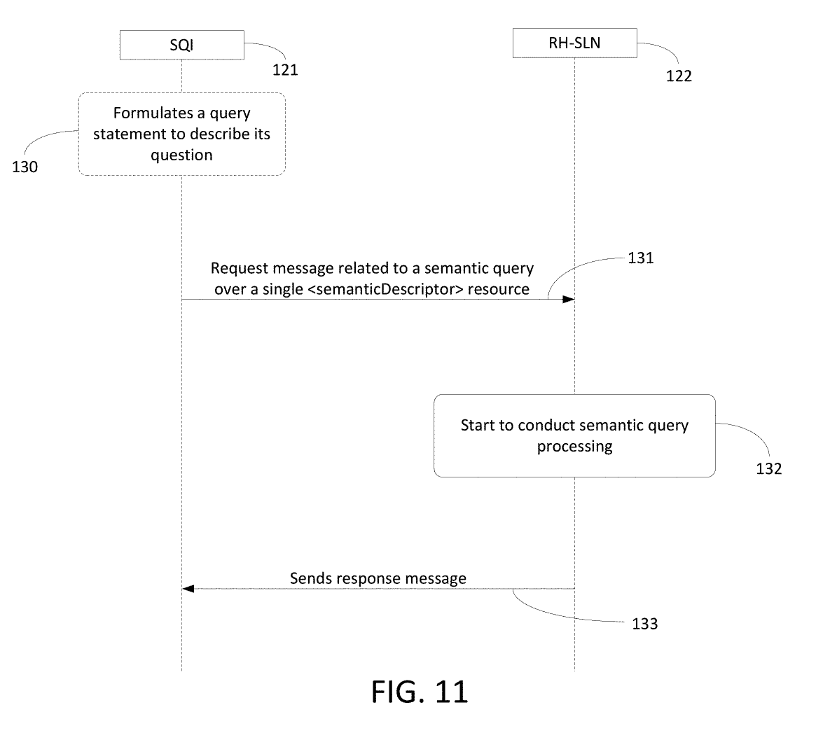

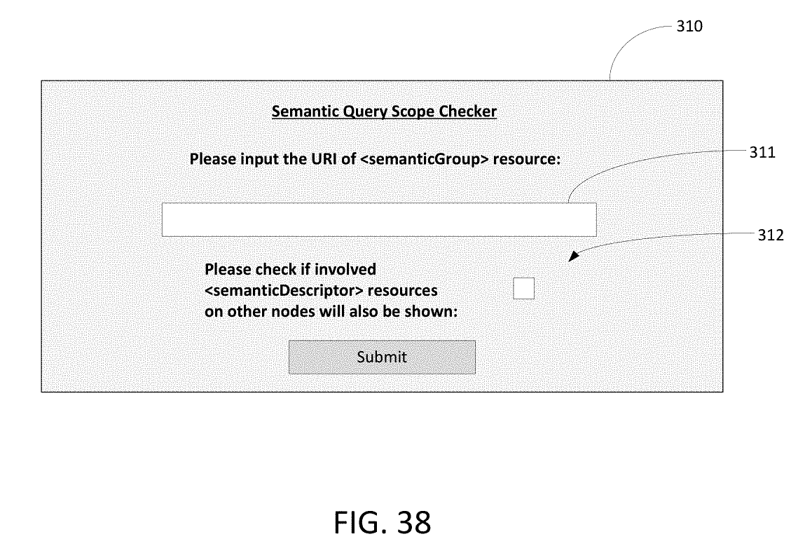

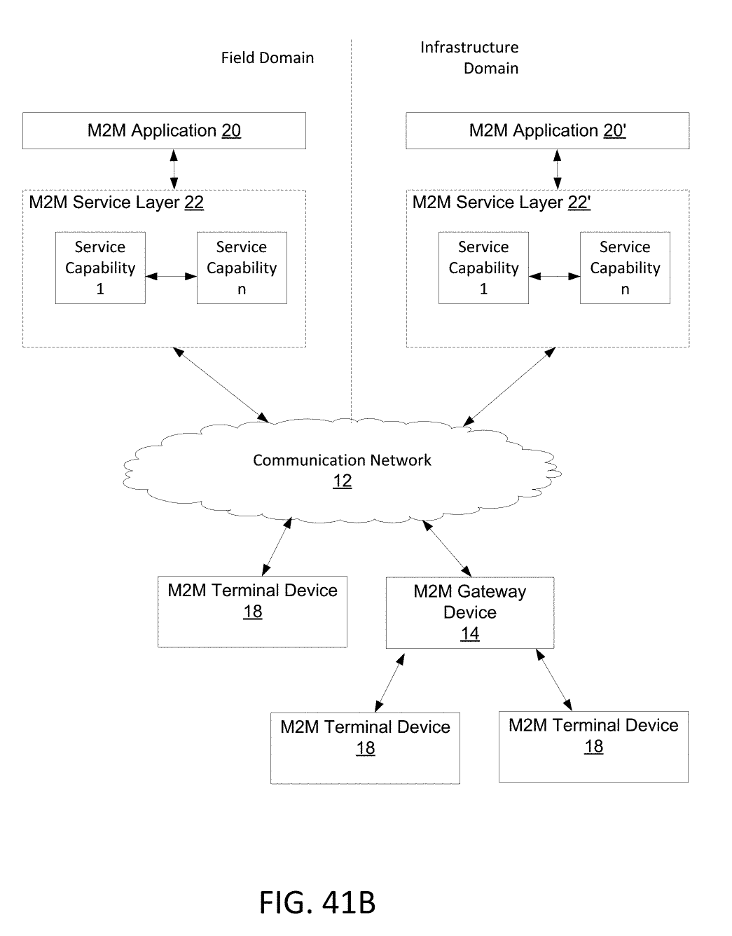

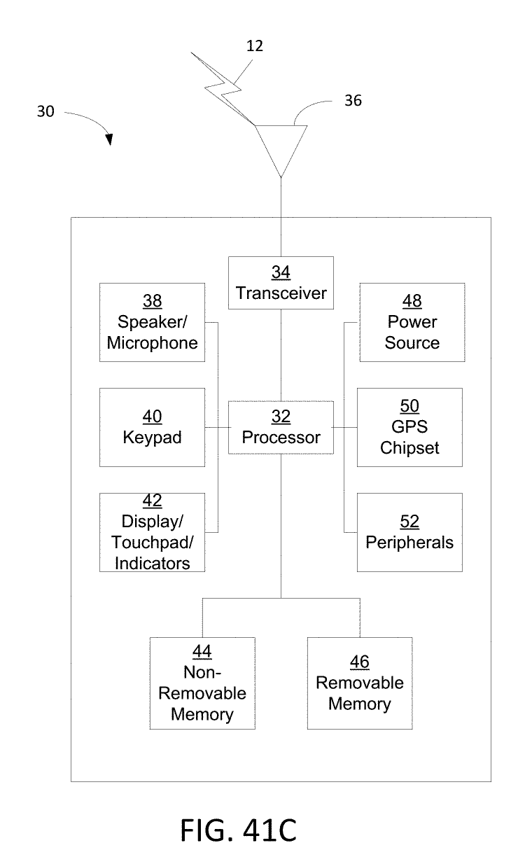

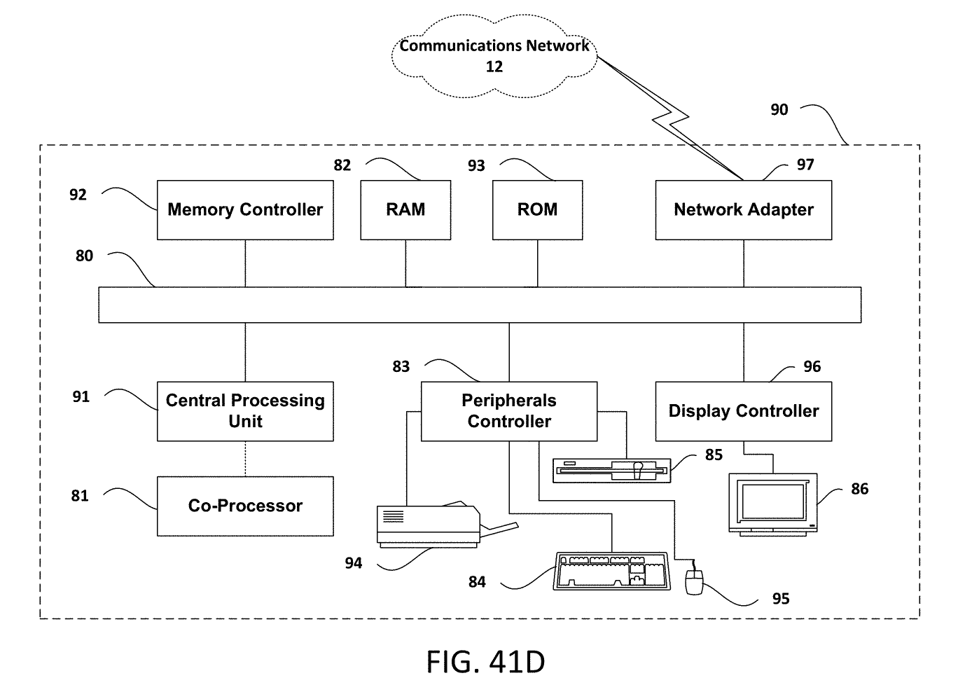

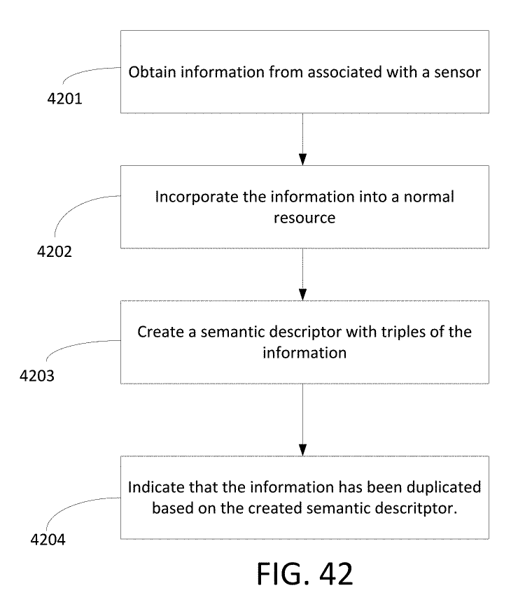

It is understood that the entities performing the steps illustrated herein, such as entities in FIG. 10-FIG. 37, may be logical entities. The steps may be stored in a memory of, and executing on a processor of, a device, server, or computer system such as those illustrated in FIG. 41C or FIG. 41D. In an example, with further detail below with regard to the interaction of M2M devices, AE 295 of FIG. 37 may reside on M2M terminal device 18 of FIG. 41A, while CSE 296 of FIG. 37 may reside on M2M gateway device 14 of FIG. 41A.

Table 3 provides definitions for commonly used terminology used herein.

TABLE 3
Terminology

| | |
|---|---|
| Normal Resource | Normal resource basically refers to the resources other |
| | than the <semanticDescriptor> resource, which could be |
| | <CSE>, <AE>, <container> etc. resources in the oneM2M |
| | context for example. |
| Resource Hosting Service-Layer | A RH-SLN is a basic service layer node, which is built |
| Node (RH-SLN) | with RESTful architecture. In other words, its service |
| | layer exposes a resource-tree as operation interface. |
| Semantic Descriptor | A semantic descriptor stores semantic descriptions and |
| | annotations of its parent resource. In oneM2M, a semantic |
| | descriptor is defined as a <semanticDescriptor> resource. |
| | Stores a semantic description pertaining to a resource and |
| | potentially sub-resources. Such a description may be |
| | according to subject-predicate-object triples as defined in |
| | the RDF graph-based data model in oneM2M. The |
| | encoding of the RDF triples used in oneM2M is defined in |
| | oneM2M TS-0004. The elements of such triples may be |
| | provided according to ontologies. |
| SL Semantic-Query Initiator or | An SQI is a logical entity that initiates a semantic query. |
| (SQI) | |
| Semantic Resource Discovery | A resource discovery process in which semantic |
| | descriptions of resources are leveraged and the purpose of |
| | semantic resource discovery is to identify resources that |
| | satisfy requests or other needs. |
| Semantic Query | Semantic query allows for queries and analytics of |
| | associative and contextual nature. Semantic queries |
| | enable the retrieval of both explicitly and implicitly |
| | derived information/knowledge based on syntactic, |
| | semantic and structural information contained in data |
| | (e.g., RDF triples). |

With regard to a first scenario, FIG. 10 illustrates a partial resource tree structure which <Device> 111 represents a temperature sensor with operation 114, operation 115, and child <semanticDescriptor> 116 resource, which includes the related semantic descriptions in terms of RDF triples. The RDF triples stored in <semanticDescriptor> 116 resource may be logically regarded as a graph in block 110. The intent of query description may be the following: “return me the number of operations supported by the device <Device> 111.” The SPARQL representation may be as follows:

| SELECT SUM (?operation) | | |
|---|---|---|
| WHERE { ?device | rdf:type | base:Device . |
| ?device | base:hasService | ?service . |
| ?service | base:hasOperation | ?operation . |
| } | | |

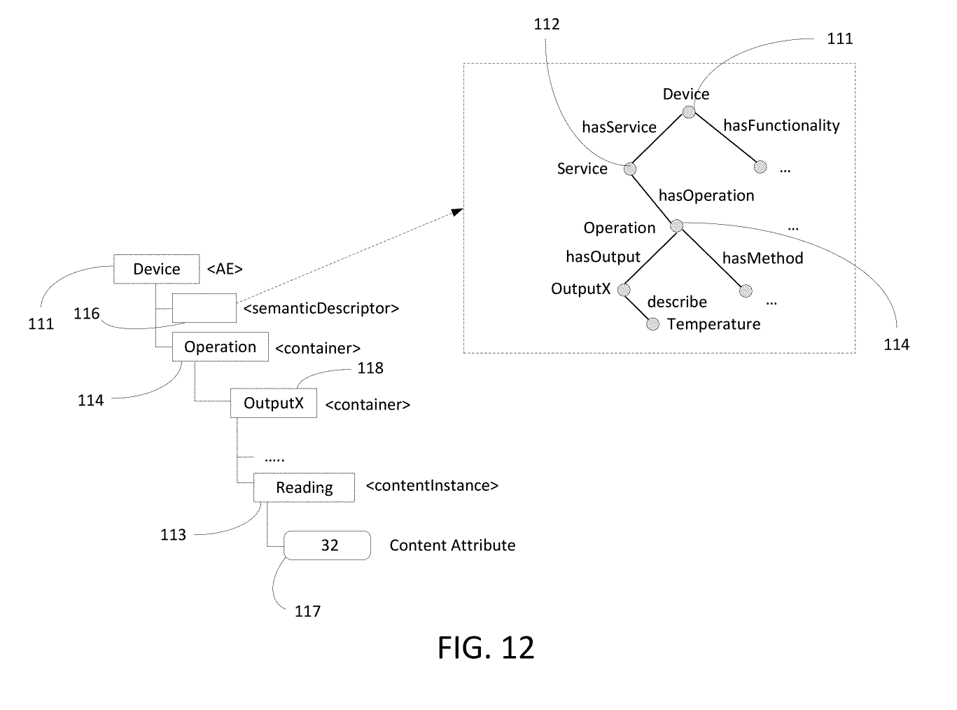

There is no detail defined conventionally (e.g., in oneM2M) regarding how to process this query. FIG. 11 illustrates an exemplary method for semantic query processing for the first scenario. At step 130, SQI 121 would like to query some information on RH-SLN 122. Accordingly, SQI 121 formulates a SPARQL query statement, like the one above, to describe its question. Service layer semantic-query initiator (SQI) 121 may be a logical entity that initiates a semantic query. Resource hosting service-layer node (RH-SLN) 122 may be a service layer node that is built with RESTful architecture. The service layer of RH-SLN 122 may expose a resource-tree as an operation interface.

At step 131, SQI 121 sends a request message to RH-SLN 122 that indicates that the request is related to a semantic query. The message may include the following parameters, which are discussed in more detail below: semantic query indicator (SQ), single resource evaluation indicator (SE), query statement (QS), or result format (RF). The SQ includes information that may indicate that the request of step 131 from SQI 121 is a semantic query to be executed. In other words, SQ indicates that the request is not for semantic resource discovery but for semantically querying or retrieving some derived information or knowledge, which may be based on a RDF triple. SE may indicate that this query is to be applied to a single <semanticDescriptor> resource. For example, when the “To” parameter of this request message is directly targeted to a <semanticDescriptor> resource, this <semanticDescriptor> resource will be the one where the semantic query is to be executed. However, when the “To” parameter of this request message is directly targeted to a normal resource, its immediate or nearest <semanticDescriptor> child resource will be the one where the semantic query is to be executed. There may be a requirement that when SQI 121 intends to conduct semantic query only over a single <semanticDescriptor> resource, the SE parameter with the appropriate value has to be included in the request message. In other words, if the SE parameter at a particular value is not included in the request message, the default scope may be all the child resources of the URI as indicated by the “To” parameter of this request (the discussions with regard to fourth scenario touches on this situation). QS stores the query statement specified by SQI 121, which may be a SPARQL query statement. Alternatively, SQI 121 may also carry its query in the semantics filterCriteria. RF indicates how the query result should be represented, which may be in plain text, JSON, or XML, format. Using the previous example, the examples values for the SQ, SE, QS and RF are given below:

| SQ=1 // “1” indicates that this is a request for a semantic | | |
|---|---|---|
| query | | |
| SE=1 // “1” indicates that this query is only targeted for a | | |
| single resource. | | |
| QS= SELECT SUM (?operation) | | |
| WHERE { ?device | rdf:type | base:Device . |
| ?device | base:hasService | ?service . |
| ?service | base:hasOperation | ?operation . |
| } | | |

RF=JSON //It indicates that the query result will be in JSON
format.

With continued reference to FIG. 11, at step 132, RH-SLN 122 receives the request from SQI 121 and conducts semantic query processing from the start point as indicated by SQI 121. Based on the “To” parameter, the targeted <semanticDescriptor> resource is queried. Once the targeted <semanticDescriptor> resource is identified, the semantic query may be executed on the targeted <semanticDescriptor> resource and yields a query result. At step 132, RH-SLN 122 sends a response message to SQI 121, in which the query result is included by using the format as indicated by SQI 121.

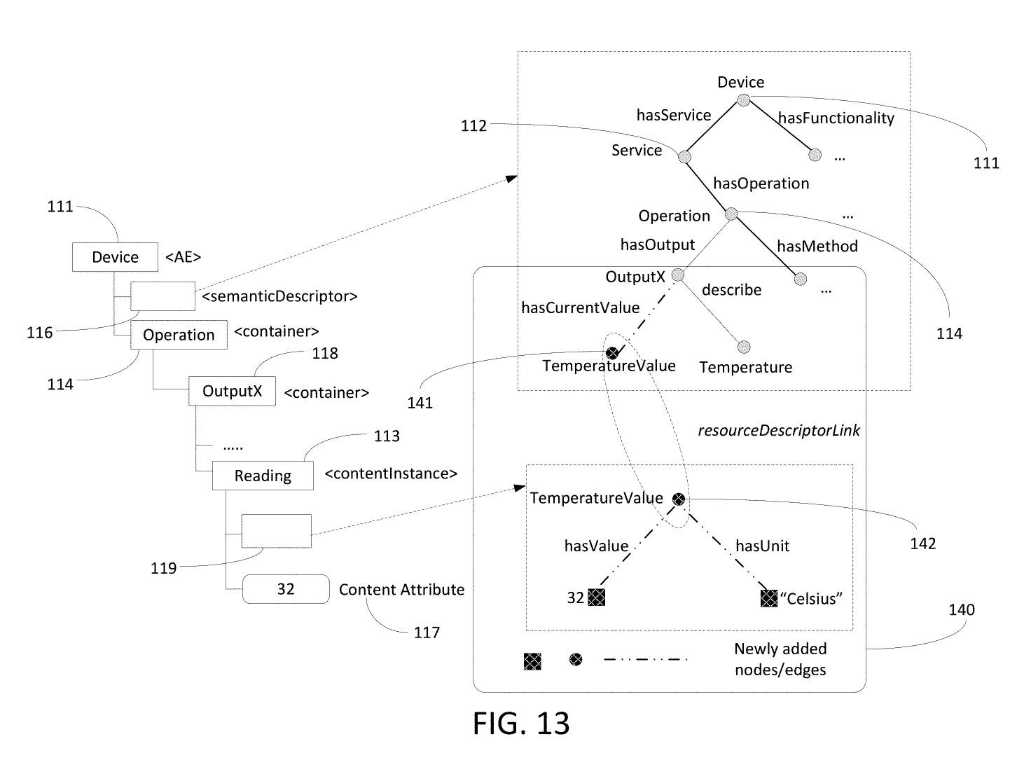

With regard to a second scenario, FIG. 12 illustrates a partial resource tree structure in which <Device> 111 represents a temperature sensor and its child <semanticDescriptor> 116 resource includes the related semantic descriptions in terms of RDF triples. The <reading> 113 is a <contentInstance> resource that stores the latest temperature reading and the value “32” is stored in the content attribute 117 of this <reading> 113 resource. The <contentInstance> resource may represent a data instance in the <container> resource. The semantic query may be associated with retrieving information that is not stored in the <semanticDescriptor> resource, e.g., some information may not be represented as RDF triples but just stored in the normal resources. Herein, the normal resource basically refers to resources other than the <semanticDescriptor> resource, which could be <CSE>, <AE>, <container> etc. resources in the oneM2M context, for example. The intent of query description may be the following: “return the sensor whose current temperature is greater than 20.”

| SELECT ?device | | |
|---|---|---|
| WHERE { ?device | rdf:type | base:Device . |
| ?device | base:hasService | ?service . |
| ?service | base:hasOperation | ?operatoin |
| ?operation | base:hasOutput | ?output |
| ?output | hasCurrentValue | ?tempValue . |

FILTER (?tempValue temp:hasValue >= 20)
}

When applying the above query directly over the <semanticDescriptor> resource of <Device> 111, conventionally no result may be returned because the “FILTER (?tempValue temp:hasValue >=20)” in the SPARQL cannot be satisfied. The reason is that the temperature value is currently not stored in the <semanticDescriptor> resource as a RDF triple. This represents a typical characteristic of existing semantic infrastructure in the sense that information stored in RDF format is mostly static since most of it is metadata description. In comparison, dynamic data is often stored in the resource tree. For example, as shown in FIG. 12, for the semantic descriptions of <Device> 111, although it describes that OutputX 118 describes the temperature aspect, but the current value of OutputX 118 (e.g., the current temperature value of Device 111) is not directly described as RDF triple and stored in this <semanticDescriptor> resource since this information changes over time. As disclosed herein, where there is an indication of “triples,” it is contemplated that there may be just one “triple.”

With reference to the second scenario, there are multiple considerations to address it. Herein, for the second scenario, the considerations are indicated by scenario 2A and scenario 2B. Disclosed herein multiple exemplary features, for example data content stored in the content attribute of the <contentInstance> resource can also be re-represented as RDF triples and stored in a <semanticDescriptor> resource. In addition, a new attribute may indicate whether the data content is re-represented as RDF triples. The usage of “resourceDescriptorLink” property may be extended to not only link two <semanticDescriptor> resources, but also link between a <semanticDescriptor> resource and a normal oneM2M contentInstance resource.

For scenario 2A, the consideration is to generally add more RDF triples to represent the information that is originally not available in the <semanticDescriptor> resource, e.g., the temperature value, which is originally only stored in content attribute 117 of the <reading> 113 resource. In other words, information that is originally stored in the normal resources can be represented as RDF triples and stored in certain <semanticDescriptor> resources. It is worth noting that for scenario 2A, in addition to the query processing, there is also maintenance procedures on RDF triples in the sense that any changes on original information that are stored in the normal resources (e.g., if the original information is created, modified, deleted, updated, etc.) should also affect related <semanticDescriptor> resources if this information were represented as RDF triples and were stored in certain <semanticDescriptor> resources. Some existing solutions can be used for supporting this maintenance related processing.

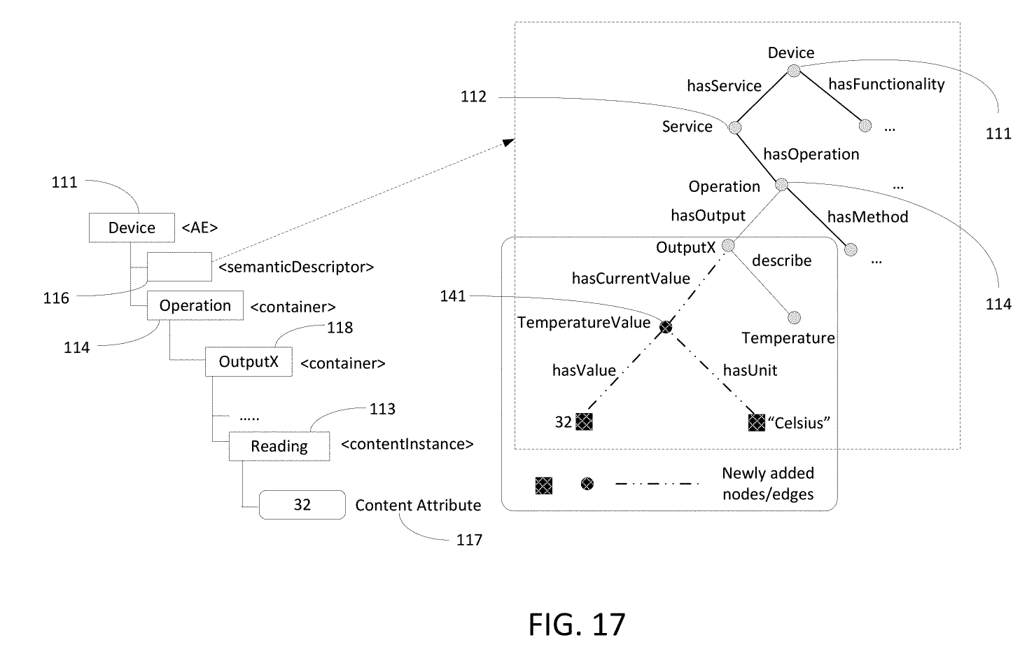

A key question of scenario 2A is where to store the triples. Alternative implementation options are discussed as below. In a first option associated with scenario 2A, for the information coming from a normal resource (e.g., the current temperature value 32 stored in the <reading> 113 resource as in FIG. 16), if the <reading> 113 resource currently does not have a <semanticDescriptor> child resource, RH-SLN 122 will create a new <semanticDescriptor> child resource (e.g., <semanticDescriptor> 119) for the <reading> 113 resource, which is to store new RDF triples that is to represent the information. In the meantime, this new <semanticDescriptor> 119 resource needs to be linked with other existing <semanticDescriptor> resources (e.g., semanticDescriptor> 116 resource) by using “resourceDescriptorLink” property or the “relatedSemantics” attribute of existing <semanticDescriptor> resource.

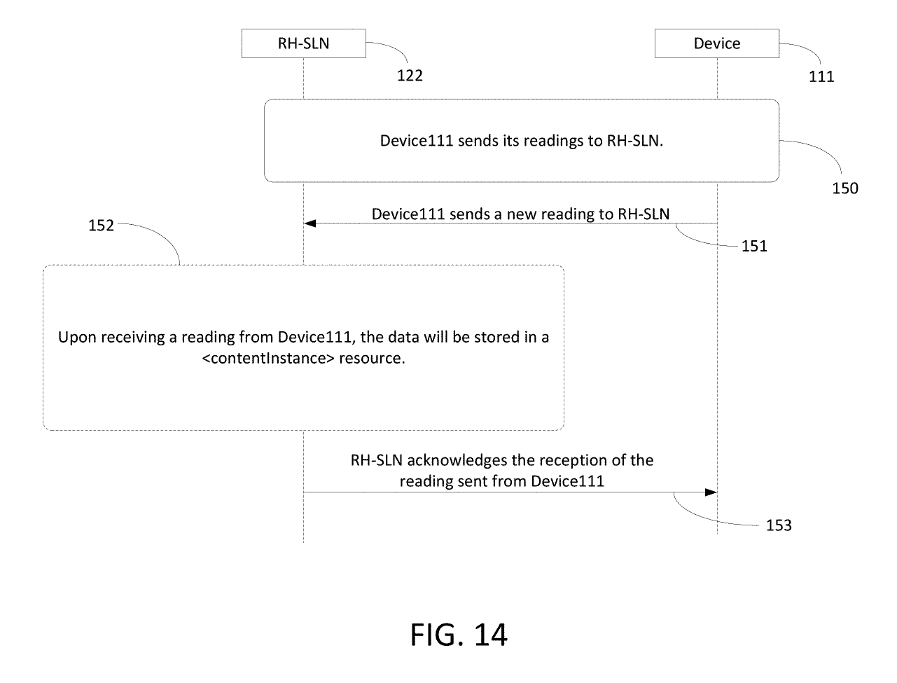

FIG. 13 helps illustrate how the first option works for scenario 2A. See block 140. As it can be seen, a new <semanticDescriptor> child resource is created for the <reading> 113 resource, along the creation of this <reading> 113 resource. In the meantime, some new triples are also created in the <semanticDescriptor> child resource of <Device> 121 so that the “resourceDescriptorLink” property can be further used to link two <semanticDescriptor> resources together through the “TemperatureValue” node 141, as discussed below.

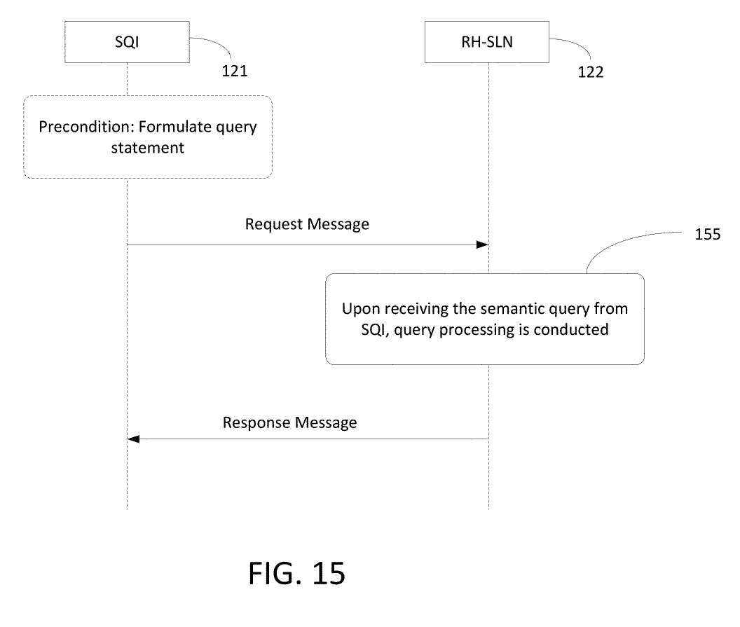

Note that in Option-1, the major effort is to clone the information that is originally not being stored as RDF triples. The meaning of clone here is to duplicate the information that is previously only stored in normal resources and represent it as RDF triples. In particular, as long as RH-SLN 122 receives new information that needs to be cloned, a clone process should be conducted. An exemplary information clone process is described as a procedure as shown in FIG. 14 and detailed descriptions are as follows by using the example shown in FIG. 13.

At step 150, device 111 is a M2M temperature device and already registered with RH-SLN 122 and it may send its readings to RH-SLN 122. <Device> 111 resource on RH-SLN 122 has a <semanticDescriptor> 116 child resource which includes its semantic descriptions. At step 151, Device 111 sends a new reading to RH-SLN 122.

At step 152, upon obtaining (e.g., receiving) the new reading from Device 111, the data may be stored in a <contentInstance> resource, e.g., the <reading> 113 resource as shown in FIG. 13. In the meantime, with the creation of this <reading> 113 resource, there are a plurality of actions that should be completed. In a first action with regard to step 152, an associated <semanticDescriptor> resource is also created for <reading> 113 resource. For instance, the current reading (e.g., value 32) may be represented as RDF triples and stored in this newly created <semanticDescriptor> 119 resource. As shown in the example of FIG. 13, for the semantic graph of the newly created <semanticDescriptor> 119 resource, it has a “TemperatureValue” node 142, which has two links. One link is to describe that the value of this node is “32” and the other link is to show the temperature unit is in Celsius. Note that in this step, it RH-SLN 122 has certain intelligence in order to generate appropriate RDF triples. For example, when Device 111 sends a reading, it may also include some semantic metadata in order to indicate that the reading is in Celsius for RH-SLN 122's awareness. Alternatively, if such information was already stored in the semantic descriptor of the parent <container> resource of <reading> 113 (e.g., the <OutPutX> 118 resource, this information will also be referred by RH-SLN 122. Another approach is that the RH-SLN 122 may use semantic reasoning to decide the measurement unit of a device based on the semantic description of this device (e.g., all the devices manufactured by Company-A are using Celsius in default). The semantic description may be considered information (e.g., RDF triples) stored in the semanticDescriptor child resource of this device.

In a second action under step 152 of FIG. 14, in order to utilize the resourceDescriptorLink to link this newly-created <semanticDescriptor> 119 resource with another <semanticDescriptor> resource (e.g., <semanticDescriptor> 116 resource, the two <semanticDescriptor> resources should overlap (e.g., overlapped nodes). However, as shown in FIG. 13, the <semanticDescriptor> 116 resource of <Device> 111 does not have any overlapped nodes with the newly-created <semanticDescriptor> 119 resource. Accordingly, the next step is to add some new triples as hooks (e.g., a way to link) to the <semanticDescriptor> 116 resource of <Device> 111. As can be seen in FIG. 13, “TemperatureValue” node 141 is also added, which is linked to OutputX 118 node through the “hasCurrentValue” property. “TemperatureValue” node 141 is a value in a triple. For example, TemperatureValue (Subject Part) hasValue (Predicate Part) 32 (Object Part). TemperatureValue is on the Subject Part. Note that it is possible that there could already be a “TemperatureValue” node 141 in the <semanticDescriptor> resource of <Device> 111, which refers to a reading of a previous time unit. In that case, adding a new “TemperatureValue” node into the <semanticDescriptor> resource of <Device> 111 is not needed, instead, triple related to the resourceDescriptorLink property of the “TemperatureValue” node 141 can be just modified such that the resourceDescriptorLink may be changed to refer to the newly-created <semanticDescriptor> 119 resource of <reading> 113.

With continued reference to the second action, it should be understood that in each RDF triple (S, P, O), each part is referred through URIs. Just like each oneM2M resource has a unique URI, the entities appeared in the Subject, Predicate or Object part of a given triple also have a unique URI. The following options may be considered with regard to assigning a value to the URI of the “TemperatureValue” nodes (node 141 and node 142) in the two <semanticDescriptor> resources. A first option is related to use of the current URI of <reading> 113. In this case, each time a new reading is received, the URI of the existing “TemperatureValue” node 141 appearing in the <semanticDescriptor> resource of <Device> 111 is updated to have the URI of the resource storing the newly-received reading. A second option is related to a system-wide special URI used by <Device> 111 to represent the “TemperatureValue” node 141 that stores its latest reading. In this case, even within the newly-created <semanticDescriptor> 119 resource of <reading> 113, its “TemperatureValue” node 142 may also have this system-wide special URI, instead of having the URI of <reading> 113. By comparison, the latter option may have better scalability and easier maintenance.

In a third action under step 152, the resourceDescriptorLink is utilized on the “TemperatureValue” nodes appearing in both <semanticDescriptor> resources (116 and 119) so that those two resources can be linked together.

At step 153, RH-SLN 122 acknowledges the reception of the reading sent from Device 111.

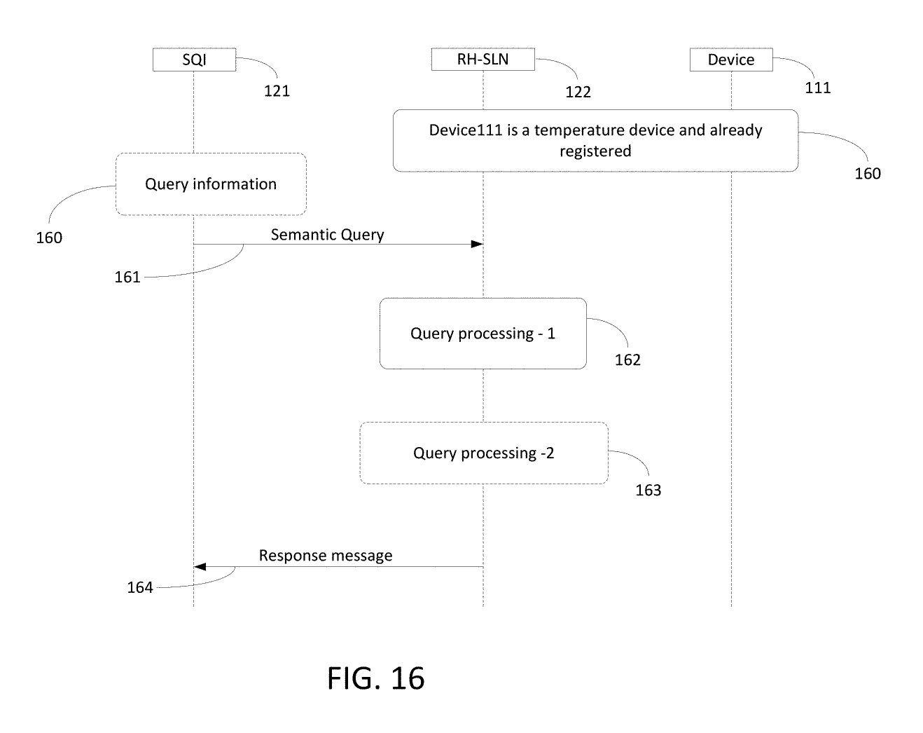

Regarding the semantic query processing stage, when a semantic query as specified in the second scenario is received by RH-SLN 122 and is to be executed on the <semanticDescriptor> 116 child resources of <Device> 111, a valid query result may be yielded because there is no missing information at this time (e.g., the value “32” is now also available as RDF triples). Such a semantic query processing is formally described as a procedure as shown in FIG. 15. Note that the general procedure for semantic query processing of FIG. 15 is similar to the one shown in FIG. 11, in which a difference between step 132 of FIG. 11 and step 155 of FIG. 15 regarding how RH-SLN 122 processes the semantic query. So in step 155, upon receiving the semantic query from SQI 121, the query processing at RH-SLN 122 is conducted with the following actions. In a first action, the SPARQL query is executed on the child <semanticDescriptor> 116 resource of <Device> 111. In a second action, if in the course of the execution, a class instance or node with one or more resourceDescriptorLink annotations is encountered, the execution is halted. In the example shown in FIG. 13, the “TemperatureValue” node 141 has a resourceDescriptorLink that refers to the newly-created <semanticDescriptor> 119 resource that stores the current temperature value “32”. In a third action, for each of <semanticDescriptor> resources that the resourceDescriptorLink refer to, the contents are added to the original content on which the SPARQL query is being executed. For example, the RDF triples describing the fact that the current temperature value of Device 111 is 32 will be added. In a fourth action, execution of the SPARQL query is continued on the enlarged content and yields the query result.

Note that FIG. 14 shows the case in which the information clone process happens once the new information is available. Accordingly, the semantic query processing as shown in FIG. 15 is independent of information clone process. Alternatively, an on-demand approach may occur in the sense that the information clone process will be triggered by the semantic query processing. As an example shown in FIG. 13, the creation of the new <semanticDescriptor> child resource of <reading> 113 may be triggered by semantic query reception event at RH-SLN 122. Accordingly, a new semantic query processing procedure is disclosed in FIG. 16, as discussed in more detail below.

With reference to FIG. 16, at step 160, Device 111 is a temperature device and already registered with RH-SLN 122. In the meantime, the <Device> 111 resource on RH-SLN 122 also has <semanticDescriptor> 116 child resource which includes its semantic descriptions. Device 111 periodically sends its readings to RH-SLN 122 and those readings are stored in the <contentInstance> child resources under the <OutputX> 118 resource. On the SQI 121 side, based on needs, later SQI 121 needs to query some information on RH-SLN 122. Accordingly, SQI 121 formulates a SPARQL query statement to describe its question. For example, assuming SQI 121 intends to do a query related to the current reading of Device 111 as discussed in the example shown in FIG. 13. At step 161, SQI 121 sends a request message to RH-SLN 122, in which it indicates that this request is a semantic query.

At step 162, upon receiving the semantic query from SQI 121, RH-SLN 122 examines the received semantic query. If the query is looking for some information that is currently not available in RDF format but may be found in other normal resources, RH-SLN 122 extracts the information and represent it as RDF triples. For this step 162, RH-SLN 122 may have certain intelligence. For example, RH-SLN 122 may already learn some useful information stored in the semantic descriptors of the <OutputX> 118 or <Device> 111 resources (e.g., the <OutputX> 118 is a <container> resource, which is to store all the readings of Device 111 and the reading unit is in Celsius). By knowing this information, RH-SLN 122 is able to locate the reading information under <OutputX> 118 resource when it is needed by a semantic query. In addition, a more advanced approach may be that RH-SLN 122 uses semantic reasoning to decide the measurement unit of a device based on the semantic description of the device (e.g., all the devices manufactured by Company-A are using Celsius by default).

With continued reference to step 162 of FIG. 16, in the example shown in the second scenario, based on semantic description of <OutputX> 118 resource, RH-SLN 122 understands that this resource stores the readings of <Device> 111. Accordingly, when the query is looking for the current reading of <Device> 111, RH-SLN 122 identifies that <reading> 113 is the resource storing the latest reading, and it then extracts the value of 32 and represent it as RDF triples. After that, an associated <semanticDescriptor> 119 resource is created for <reading> 113 resource, which also stores the latest reading information but in RDF format. In addition, the newly created <semanticDescriptor> 119 resource may also be linked with other <semanticDescriptor> resources (e.g., the <SemanticDescriptor> 116 resource of <Device> 111 in example) through the resourceDescriptorLink property. Accordingly, it may support future semantic query.

Subsequently, at step 163, the query processing at RH-SLN 122 is conducted, which is similar to corresponding FIG. 15 (step 155). At step 164, RH-SLN 122 sends back a response message to SQI 121, in which the query result is included by using the format as indicated by SQI 121 (as provided in step 161).

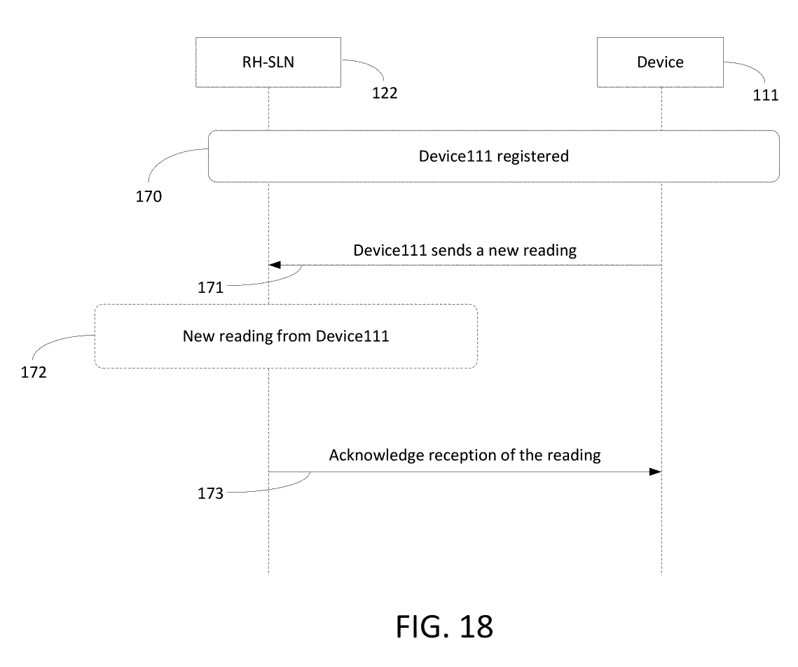

FIG. 17 helps illustrate how the second option works for scenario 2A. In summary (with reference to FIG. 13 and FIG. 17), for the information coming from normal resource (e.g., <reading> 113 resource), if <reading> 113 resource currently does not have a <semanticDescriptor> 119 child resource, RH-SLN 122 will add the new RDF triples that are representing information directly to the <semanticDescriptor> 116 resource of <device> 111 resource (parent or ancestor). If <reading> 113 resource currently already has a <semanticDescriptor> 119 child resource, the new RDF triples will be directly added to this <semanticDescriptor> 119 resource.

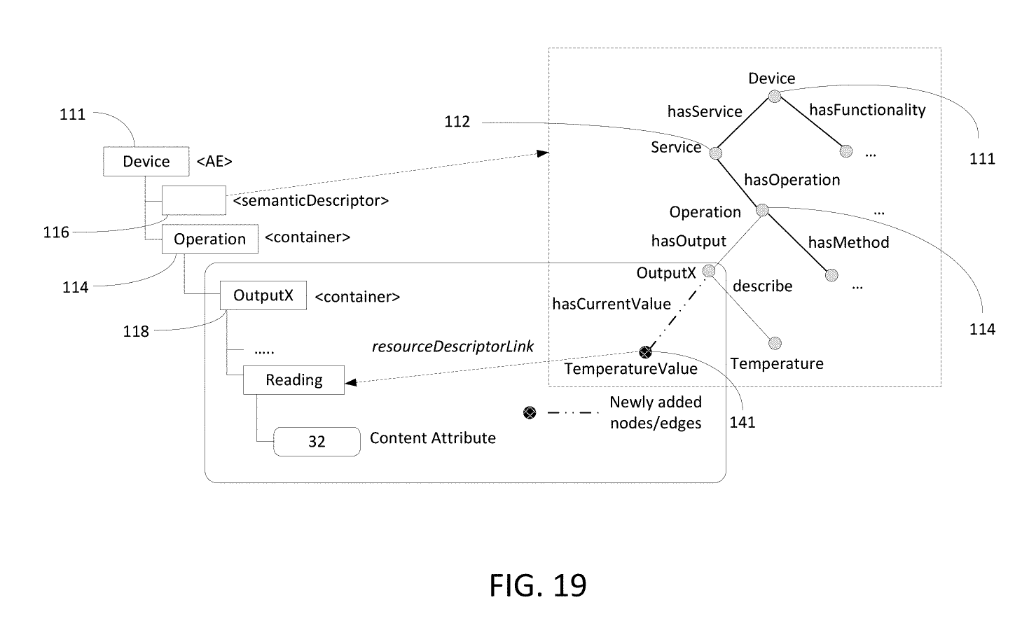

With continued reference to FIG. 17, there is no <semanticDescriptor> resource created for the <contentInstance> resource at this time and all the new triples are directly added to the <semanticDescriptor> 116 child resource of <Device> 111. Similar to FIG. 14, an information clone process for the second option of scenario 2A is formally described as a procedure as shown in FIG. 18 (the steps are similar to the ones in FIG. 14 except step 152). At step 170, Device 111, for example, is a M2M temperature device and already registered with RH-SLN 122. Device 111 may send its readings to RH-SLN 122. In the meantime, <Device> 111 resource on RH-SLN 122 has <semanticDescriptor> 116 child resource that includes its semantic descriptions. At step 171, Device 111 sends a new reading to RH-SLN 122.

At step 172 of FIG. 17, upon receiving a new reading from Device 111, the data may be stored in a <contentInstance> resource, e.g., the <reading> 113 resource as shown in FIG. 17. In the meantime, with the creation of the <reading> 113 resource, other actions are completed. In a first action, the current reading, e.g., value 32, is represented as RDF triples. For example, those triples may describe a graph in which it has a “TemperatureValue” node 141, which has two links. One link is to describe that the value of this node is “32” and the other link is to show the temperature unit is in Celsius. In a second action, those newly-created RDF triples may be directly added to existing related <semanticDescriptor> 116 resource. In our example, <semanticDescriptor> 116 resource of <Device> 111 may be the place to store those newly-created triples. As shown in FIG. 17, when the new triples are added, “TemperatureValue” node 141 is also linked to OutputX 118 node through the “hasCurrentValue” property. Note that it is also possible that there may already be a “TemperatureValue” node (e.g., “TemperatureValue” node 142 in the <semanticDescriptor> resource of <Device> 111), which refers to a reading of a previous time unit. In that case, there is no need to create any new triples, instead the existing RDF triples may be updated and used for representing the latest reading of Device 111 in order to reflect the real or most up-to-date reading, e.g., 32. Similarly, another consideration of the second action is that the URI of the “TemperatureValue” nodes appear in the <semanticDescriptor> resources of <Device> 111, it could have the following options. In a first option, use the current URI of <reading> 113. In this case, in each time, as long as a new reading is received, the URI of the existing “TemperatureValue” node 141 appeared in the <semanticDescriptor> 116 resource of <Device> 111 needs to be updated to have the URI of the resource storing the newly-received reading. In a second option a system-wide special URI may be used by <Device> 111 to represent the “TemperatureValue” node 141 that stores its latest reading. By compassion, the latter option may assist with scalability or ease of maintenance.

At step 173, RH-SLN 122 acknowledges the reception of the reading sent from Device 111. Accordingly, the query processing for the query in this second scenario may be simpler since there is no missing information in this single <semanticDescriptor> 116 child resource of <Device> 111, and only one <semanticDescriptor> 116 resource will be involved when processing the query.

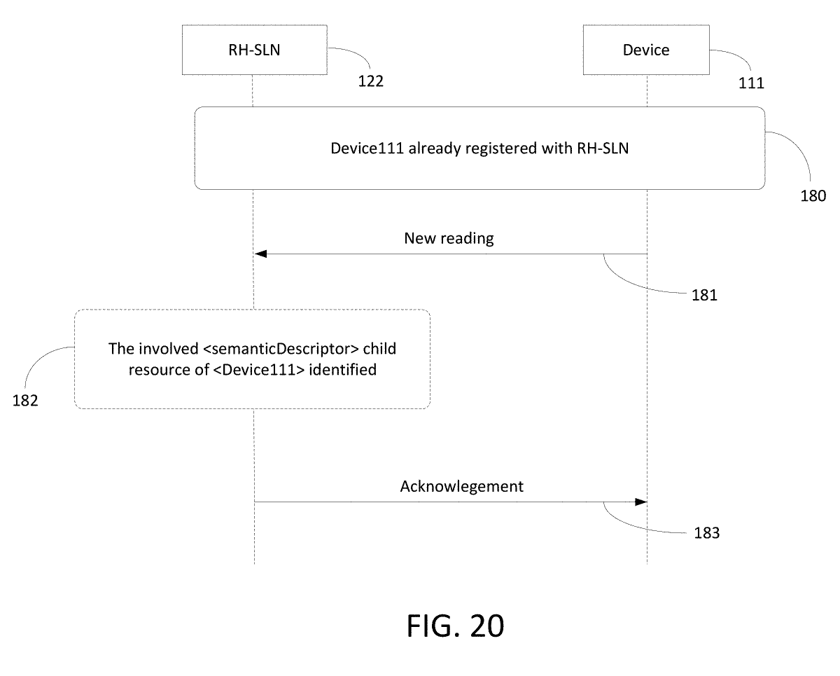

In scenario 2B, information that is originally stored in the normal resources may not be represented as RDF triples or stored in <semanicDescriptor> resources. In particular, for the information coming from a normal Resource-A (e.g., <reading> 113 resource as in FIG. 19), the <reading> 113 resource itself will be referenced by “resourceDescriptorLink” property or the “relatedSemantics” attribute of <semanticDescriptor> 116 resource as defined in oneM2M. In other words, if the RDF triples in a specific <semanticDescriptor> 116 resource is related to the information stored in <reading> 113 resource, this <semanticDescriptor> 116 resource will be linked to <reading> 113 resource (note that <reading> 113 resource is a normal oneM2M resource). In other words, the usage of “resourceDescriptorLink” property is now extended to not only link two <semanticDescriptor> resources (as defined by oneM2M), but also link between a <semanticDescriptor> resource and a normal oneM2M resource. Alternatively, instead of overloading the existing resourceDescriptorLink property, a new property called “informationLink” may be proposed for supporting this purpose.

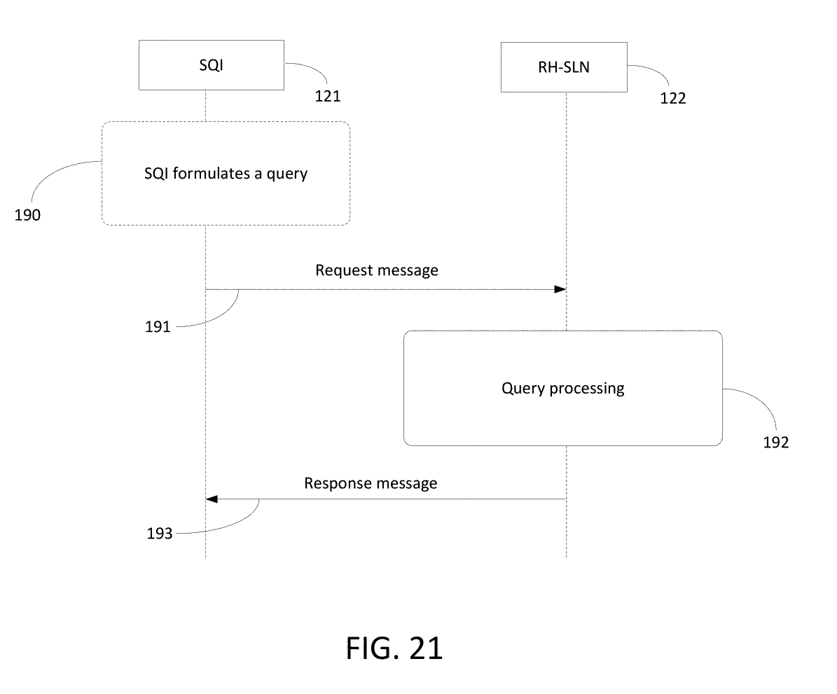

With reference to FIG. 19, as it can be seen, for the “TemperatureValue” node 141 in the <semanticDescriptor> child resource of <Device> 111, it has a resourceDescriptorLink property, which now refers to a <contentInstance> resource, e.g., <reading> 113. FIG. 20 illustrates information linking method for scenario 2B. Note that most of steps are similar to the ones in FIG. 14 except step 152 in which information clone process is not adopted at this time, by comparing, an information linking procedure. Below is description of the method flow of FIG. 20 with reference to FIG. 19.

At step 180, Device 111 is a M2M temperature device and already registered with RH-SLN 122 and may send its readings to RH-SLN 122. In the meantime, <Device> 111 resource on RH-SLN 122 has a <semanticDescriptor> child resource which includes its semantic descriptions. At step 181, Device 111 sends a new reading to RH-SLN 122.

At step 183, upon receiving the new reading from Device 111, the data may be stored in a <contentInstance> resource (e.g., the <reading> 113 resource as shown in FIG. 19). Assuming that in the example of scenario 2B, the RH-SLN 122 is configured by the administrator that the latest readings of all the temperature devices should be able to be retrieved through a semantic query, the RH-SLN 122 will then keep track of the reading submissions for those devices. Accordingly, with the creation of the <reading> 113 resource, the following actions may be triggered. In a first action, RH-SLN 122 first identifies the most appropriate <semanticDescriptor> child resource of <Device> 111 that can be used in linking the information stored in the <reading> 113 resource. Usually, it may be the <semanticDescriptor> 116 child resource of the direct parent if available. Otherwise, in our example, the <semanticDescriptor> child resource of <Device> 111 will be selected.

In a second action under step 183, some new triples may be added into the <semanticDescriptor> 116 child resource of <Device> 111 in order to represent “a current temperature reading”, e.g., the “TemperatureValue” node 141 as shown in FIG. 19. In the meantime, the “TemperatureValue” node 141 is also linked to OutputX 118 node through the “hasCurrentValue” property. Note that it is also possible that there could may be “TemperatureValue” node 141 in the <semanticDescriptor> 116 resource of <Device> 111, which refers to a reading of a previous time unit. In that case, new triples do not need to be created, instead, existing RDF triples may be updated so that the resourceDescriptorLink of “TemperatureValue” node 141 may refer to the latest reading, e.g., <reading> 113 resource. Alternatively, the resourceDescriptorLink of “TemperatureValue” node 141 may refer to the <latest> child resource of <OutputX> 118, which is a <container> type of resource and include the <reading> 113 resource. Similarly, regarding the URI of the “TemperatureValue” node 141 appeared in the <semanticDescriptor> 116 resources of <Device> 111, it is disclosed that in this case, a system-wide special URI may be used by <Device> 111 to always represent the “TemperatureValue” node 141 that stores its latest reading. Accordingly, the following triple may be added such that the resourceDescriptorLink of “TemperatureValue” node 141 refers to <reading> 113:

URI of “TemperatureValue” node 141
oneM2M:resourceDescriptorLink
   URI of <reading> 113 resource

At step 183, RH-SLN 122 acknowledges the reception of the reading sent from Device 111.

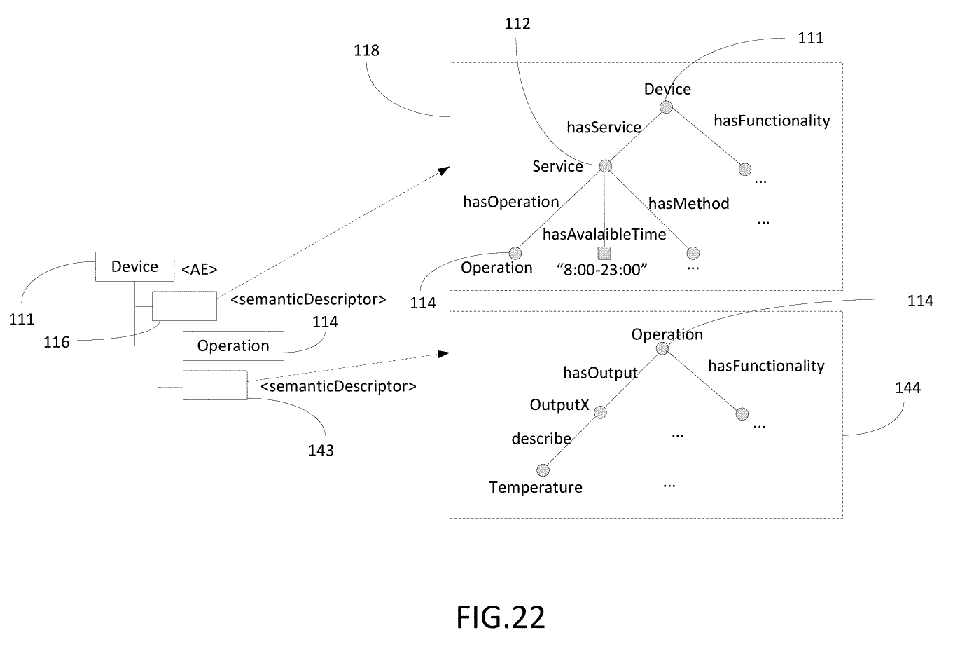

Regarding the semantic query processing stage for scenario 2B, when a semantic query as specified is received by RH-SLN 122 and is to be executed on the <semanticDescriptor> 116 child resources of <Device> 111, a valid query result may be yielded since there is no missing information (e.g., the value “32” is now also available since the resourceDescriptorLink of “TemperatureValue” node 141 is now referring to <reading> 113) at this time. Such a semantic query processing is formally described as a procedure as shown in FIG. 21. Note that the general procedure for semantic query processing of FIG. 21 is similar to the one shown in FIG. 11, with a difference being between step 132 of FIG. 11 and step 182 of FIG. 21 regarding how RH-SLN 122 processes the semantic query.

At step 192, upon receiving the semantic query from SQI 121, the query processing at RH-SLN 122 is conducted. The SPARQL may be executed on the child <semanticDescriptor> 116 resource of <Device> 111. If in the course of the execution, a class instance or node with one or more resourceDescriptorLink annotations is encountered, the execution is halted. In our example shown in FIG. 19, the “TemperatureValue” node 141 has a resourceDescriptorLink that refers to a <contentInstance> resource, e.g., <reading> 113, which stores the latest temperature value “32”. For each of such resources that the resourceDescriptorLink refer to, the contents are added to the original content on which the SPARQL query is being executed. For example, new RDF triples will be created and added in order to represent the fact that the current temperature value of Device 111 is 32. The execution of the SPARQL query is continued on the enlarged content which is based on the aforementioned addition to the original content and the query result is yielded.

Alternatively, instead of just storing a simple “32” in the <contentInstance> resource, it is also possible that the <contentInstance> may directly store RDF triples. For example, a triple “URI of “TemperatureValue” node 141 hasValue 32” can be directly stored in the <contentInstance> resource. In addition, for this scenario, the next texts describe all the possible cases who can conduct the information clone process (i.e., to transfer the content in <contentInstance> resource to RDF triples and store the RDF triples in <semanticDescriptor> resource) as discussed in the previous sections. The following options are all alternative solutions: 1) when a data reading is received by a RL-SLN, it will clone the original reading and represent as RDF triples and store in a <semanticDescriptor> child resource, which is the major case as discussed in the previous sections; 2) Another case, for a device as an originator, when it sends a reading to a RL-SLN, if the device itself has semantic capability, it can also directly send its reading as RDF triples to the RL-SLN and creates a <semanticDescriptor> child resource to the previously-created <contentInstance> resource that store the original reading/content; 3) A device sends a data reading to a RL-SLN and a <contentInstance> is created to store the original readings. If both this device as well as RL-SLN do not have semantic capability, other entities may also help. For example, in a later time, another entity who has the semantic capability (e.g, another AE or CSE in the context of oneM2M) can read the original content in the <contentInstance> resource, duplicate the content as RDF triples, and then create a <semanticDescriptor> child resource to store the RDF triples.

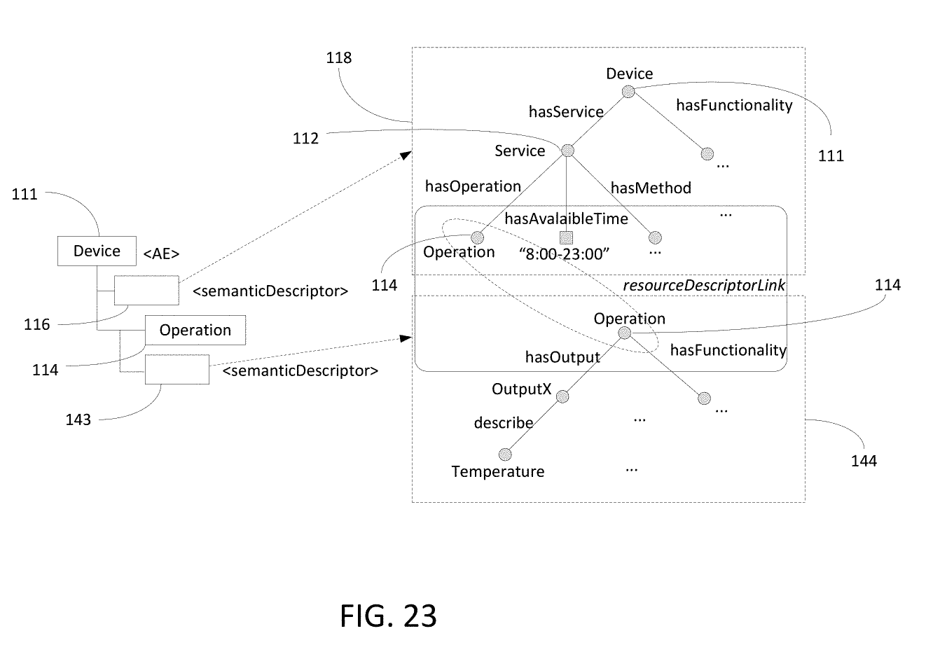

With reference to the third scenario, a semantic query may request information that may be stored in multiple different <semanticDescriptor> resources. In particular, those <semanticDescriptor> resources may be related to each other in the sense that there could be some overlapped nodes among those different <semanticDescriptor> resources. Note that the semantic descriptions in a <semanticDescriptor> resource conceptually form a graph (e.g., block 118 and block 144 of FIG. 22), and a node (e.g., device 111 in FIG. 22).

Below is further discussion with regard to the third scenario. FIG. 22 illustrates a partial resource tree structure in which <Device> 111 represents a temperature sensor and its child resource <semanticDescriptor> includes the related semantic descriptions in terms of RDF triples. In the meantime, <Device> 111 has a child resource representing its operation (e.g., <Operation> 114), and <Operation> 114 also has its own <semanticDescriptor> 143 resource. The <semanticDescriptor> 116 resource and <semanticDescriptor> 143 resource are related to each other since both of them are describing some aspects of <Device> 111 and both of them have the same node representing “Operation” 114. The intent of query description may be the following: “return me the available time of a service for a given device and this service has an operation whose output describes a temperature aspect.” The SPARQL representation may be as follows:

SELECT ?availableTime

| | | |
|---|---|---|
| WHERE { ?device | rdf:type | base:Device |
| ?device | base:hasService | ?service |
| ?service | base:hasAvailableTime | ?availableTime |
| ?service | base:hasOperation | ?operation |
| ?operation | base:hasOutput | ?output |
| ?output | base:describe | temp:TemperatureAspect |
| } | | |

In this example, when applying the above query directly over the <semanticDescriptor> 116 child resource of <Device> 111 in a conventional situation, no result may be returned because some of semantic information related to <Operation> 114 is missing from the <semanticDescriptor> child resource of <Device> 111. In particular, the information is stored in the <semanticDescriptor> child resource of <Operation> 114. This situation is considered in more detail below in view of semantic query processing.

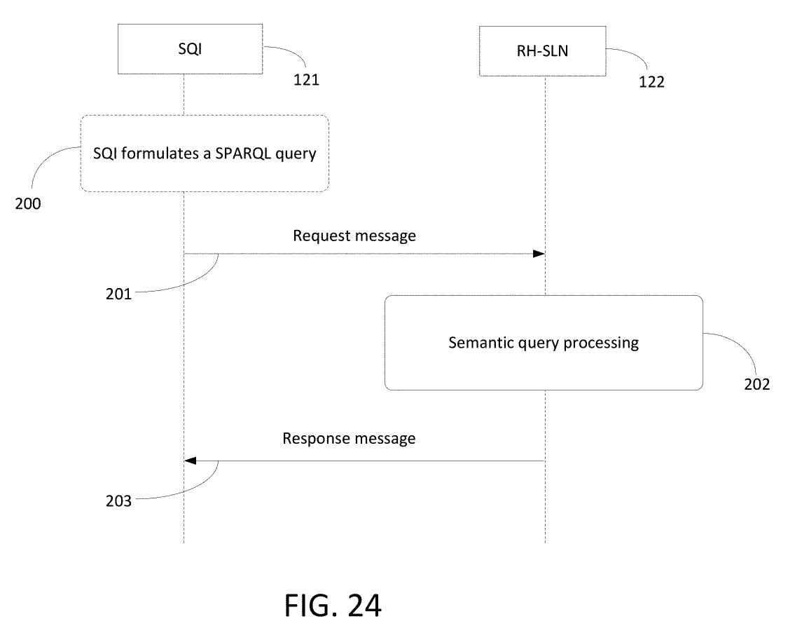

The considerations of the third scenario are similar to scenario 2A (option-1), in which the conventional existing resourceDescriptorLink defined (e.g., in oneM2M will be utilized. As shown in FIG. 23, “resourceDescriptorLink” property is used such that two <semanticDescriptor> resources may be linked together through Operation 114 node.

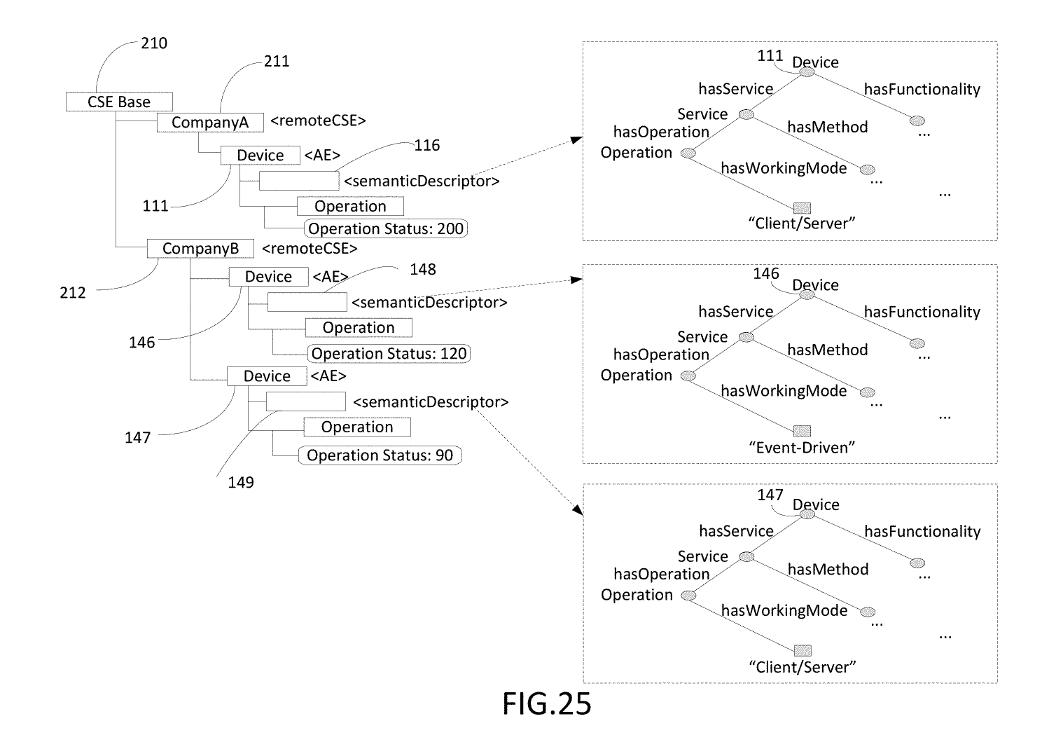

Regarding the semantic query processing stage, when a semantic query as specified in Use Case 3 is received by RH-SLN 122, this query is executed on the child <semanticDescriptor> resource of <Device> 111, it still can also find and access the triples in the <semanticDescriptor> child resource of <OperationA> and finally yields the valid query result. Note that the general procedure for semantic query processing of the third scenario as shown in FIG. 24 similar to the one shown in FIG. 11, and the most significant difference is with regard to step 202 of FIG. 24 regarding how RH-SLN 122 processes the semantic query. At step 202, upon receiving the semantic query from SQI 121, the query processing at RH-SLN 122 is conducted as follows. The SPARQL query is executed on the child <semanticDescriptor> resource of <Device> 111. If in the course of the execution, a class instance or node with one or more resourceDescriptorLink annotations is encountered, the execution is halted. In our example, the operation 114 node has a resourceDescriptorLink that refers to the child <semanticDescriptor> resource of <Operation> 114 resource. For each such resource that the resourceDescriptorLink refer to, the contents are added to the original content on which the SPARQL query is being executed. For example, the RDF triples in the <semanticDescriptor> child resource of <Operation> 114 resource may be added. The execution of the SPARQL query is continued on the enlarged content (based on the aforementioned addition of RDF triples) and yields the query result.

With reference to the fourth scenario, may request information that may be stored in multiple different <semanticDescriptor> resources. In particular, those <semanticDescriptor> resources may not even be related to each other (which is different from the third scenario). Note that “peer” basically means that although those <semanticDescriptor> resources are unrelated and describe different resources individually (e.g., a number of <temperature-sensor> resources in a region), but those temperature sensors are peers to each other and have the same type of functions. For example, two <semanticDescriptor> resources may describe two individual temperature devices respectively and those two temperature devices or their respective <semanticDescriptor> resources may be regarded as peers since e.g., they are the same type, or in same region, etc. This is different from scenario 3 which addresses two <semanticDescriptor> are to describe the same device, and then they may have something in common.

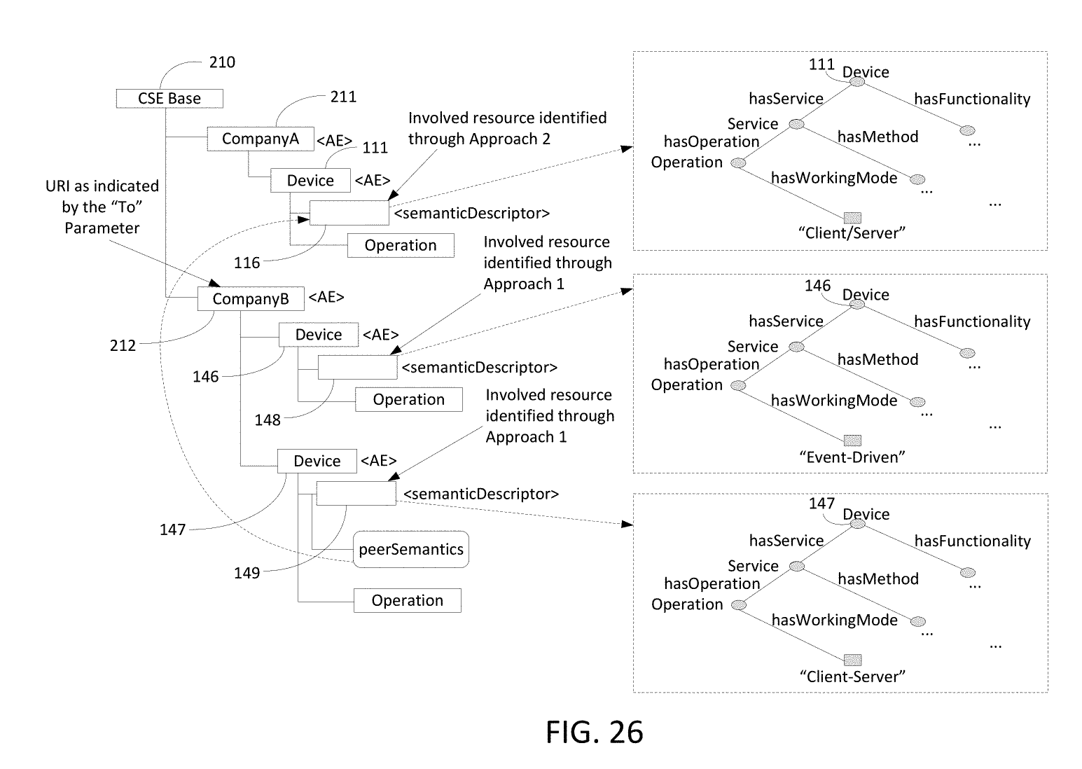

Below is further discussion with regard to the third scenario. FIG. 25 illustrates a partial resource tree structure in which <Device> 111, <Device > 146, and <Device> 147 represents three devices, and each of them has a child resource <semanticDescriptor> storing their respective semantic descriptions. Accordingly, those three <semanticDescriptor> resources are the peers to each other since they are describing different devices. In addition, those three sensors may belong to different companies (e.g., <Device> 111 is the child resource of <CompanyA> while <Device> 146 and <Device> 147 are the child resource of <CompanyB>). The intent of query description may be the following: “return me the working modes of the operations of all devices from Company A and Company B.” The SPARQL representation may be as follows:

| | | |
|---|---|---|
| SELECT ?mode | | |
| WHERE { ?device | rdf:type | base:Device |
| ?device | rdf:is-from | CompanyA or CompanyB. |
| ?device | base:hasService | ?service |
| ?service | base:hasOperation | ?operation |
| ?operation | base:hasWorkingmode | ?mode |
| } | | |

In this example, when applying the above query directly over the root resource <CSEBase> 210 of a CSE node, it needs to evaluate three different and unrelated <semanticDescriptor> resources since each of them represents a different device. However, currently there are no conventional details defined (e.g., in oneM2M) regarding how to process such a query if it requires information from multiple peer or unrelated <semanticDescriptor> resources.

In the basic solution, for a given semantic query, the determination of the query scope for the potentially involved <semanticDescriptor> resources may leverage multiple approaches. In a first approach, given the “To” parameter as indicated in the request message carrying the semantic query, all the <semanticDescriptor> resources under the URI as indicated by the “To” parameter will be involved, e.g., the scope includes the child resources under the URI as indicated by the “To” parameter. In addition, oneM2M also defines the “level” and “offset” parameters for limiting the search scope. Therefore, if those two parameters are in place, it will also affect the query scope accordingly. In a second approach, a new attribute called “peerSemantics” is proposed for the <semanticDescriptor> resource. In particular, for the <semanticDescriptor> resources as identified in the first approach, their “peerSemantics” attributes may also be checked, through which more <semanticDescriptor> resources may be identified as involved resources (which means the query scope will also include those <semanticDescriptor> resources indicated by the disclosed “peerSemantics” attribute). Note that the existing “relatedSemantics” attribute defined by oneM2M is to link related <semanticDescriptor> resources together for a single SPARQL processing.

In comparison, the proposed “peerSemantics is to link peer <semanticDescriptor> resources, and the semantic query may be executed on each of those peer <semanticDescriptor> resources individually. This is a major reason why a new “peerSemantics” attribute is proposed, in addition to the existing “relatedSemantics” attribute (otherwise, the system may not have a way to tell the real relationship between two <semanticDescriptor> resources). For example, consider a situation in which a SPARQL Query-1 is applied on a specific <semanticDescriptor-1> resource: if there is a “relatedSemantics” which links to another <semanticDescriptor-2> resource, the content in <semanticDescriptor-2> resource will be integrated with that in <semanticDescriptor-1> resource, and then Query-1 will be executed on the integrated contents. By comparison, if there is a “peerSemantics” which links to another <semanticDescriptor-2> resource, then the query processing will be different in the sense that Query-1 will be individually applied both on semanticDescriptor-1> resource and <semanticDescriptor-2> resource, and each execution may return a partial query result. Those <semanticDescriptor> resources as identified through the first approach and the second approach may be the resource set for a particular query processing to be executed.

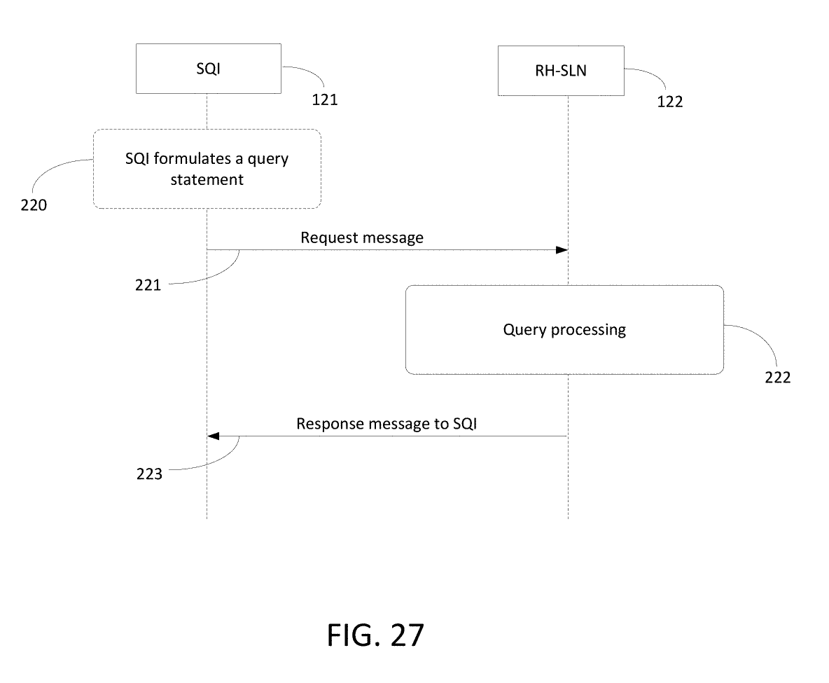

Below the fourth scenario is discussed further. FIG. 26 illustrates how “peerSemantics” may help to address the issue with query scope. Here, it is assumed that SQI 121 only has the limited knowledge for the resource structure at RH-SLN 122 and it only knows the URI of <CompanyB> through a previous resource discovery. SQI 121 now has a new query in terms of “return me the working modes of the operations of all devices from all the companies.” One way for SQI 121 to send this query directly target at <CSEBase> 210 such that the devices under <CSEBase> 210 can be discovered. However, the overhead for this operation may be considerable. With the proposed “peerSemantics” property, it may enable SQI 121 to still send its query targeted at <CompanyB>. Accordingly, if one of the devices under <CompanyB> (e.g., <Device> 147 as shown in the example) has the “relatedSemantics” to link to other devices in other companies (e.g., the device <Device> 111 from a different company, <CompanyA>) the query processing may still find all the needed devices with the help of “peerSemantics” property.

As can be seen in FIG. 26, in the basic solution, finding the potential involved <semanticDescriptor> resources can be done through the proposed Approach 1 and Approach 2, which may be used at the same time. In the meantime, the query request may be mapped to a single RETRIEVE message, and the query starting point may be based on the URI as specified by the “To” parameter. In the meantime, Approach 1 allows discovery of the involved <semanticDescriptor> resources under the URI as specified by the “To” parameter, while Approach 2 allows to discover other involved <semanticDescriptor> resources which may not reside under the URI as specified by the “To” parameter, e.g., could be anywhere in the resource tree (although it may need to be compliant to certain access control policies). For example, when a semantic query as specified in the fourth scenario is received by RH-SLN 122 and the “To” parameter is towards the URI of <CompanyB>, an accurate query result will be yielded since there is no missing information (e.g., <Device> 111 will not be missed at this time).

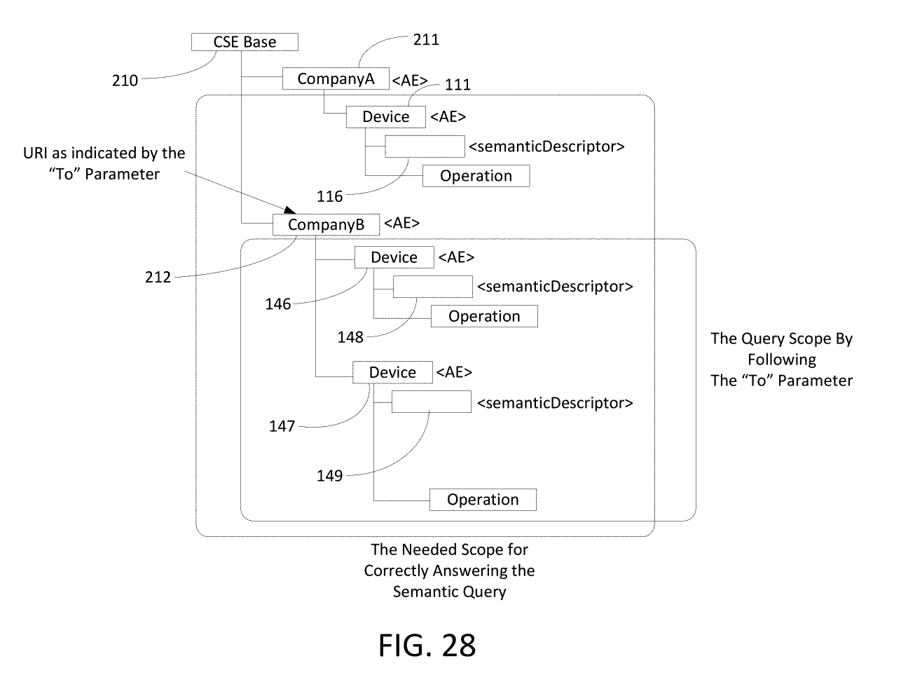

Regarding the semantic query processing stage, it is formally described as a procedure as shown in FIG. 27. Note that the general procedure for semantic query processing of FIG. 27 is similar to the one shown in FIG. 11, and the only difference is step 222 regarding how RH-SLN 122 processes the semantic query, which is discussed in details as follows. At step 222, upon receiving the semantic query from SQI 121, the query processing at RH-SLN 122 is conducted in the following actions. In a first action, upon receiving the request from an SQI (e.g., SQI 121), the receiver (e.g., RH-SLN 122) may start to conduct semantic query processing from the start point as indicated by the “To” parameter in the request message. In particular, RH-SLN 122 may first identify all the potential involved resources by using Approach 1 and Approach 2 as defined earlier. In the example, <Device> 111, <Device> 146, and <Device> 147 may be identified as shown in FIG. 26. In a second action with reference to FIG. 26, for each potentially involved <semanticDescriptor> resource, RH-SLN 122 further evaluate whether the semantic query can be executed on it, based on certain access control policy. If so, such a resource may become a formal involved resource.

In a third action of step 222, for each formal involved <semanticDescriptor> resource, the semantic query is executed on it. If there is a valid query result, this query result may be added to the final result set. In the meantime, the query processing on those formal involved resources may be conducted independently to each other. In a fourth action, after the formal involved resources have been evaluated with the query, the final result set will contain the final query result, and be returned to SQI 121.

In the previously discussed basic solution, it is assumed that the resource URI as indicated by the “To” parameter largely decides where the query processing starts, e.g., the “To” (or the like) parameter is used for deciding the default query scope. In fact, the query scope may be a major issue that may affect the semantic query processing especially when a given semantic query involves multiple <semanticDescriptor> resources. The enhancements discussed below try to address query scope related issues.

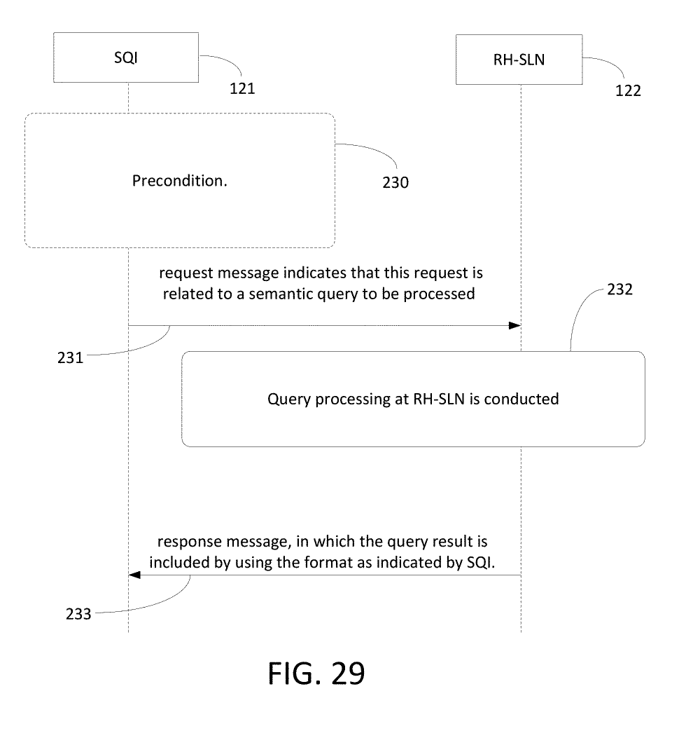

A significant issue associated with query scope is that if the query scope is compliant to existing oneM2M specifications, for example, it may not be equal to the needed query scope for successfully and correctly answering a particular semantic query. For example, as it may be seen in FIG. 28, assuming an SQI sends a semantic query request to a RH-SLN 122 which hosts a resource tree rooted at <CSEBase> 210, in which the “To” parameter is targeted to the URI of <CompanyB> 212 and the semantic query in summary indicates “return me the working modes of the operations of all devices from Company A 211 and Company B 212”. In such a case, based on existing oneM2M specification, the <semanticDescriptor> child resources of <Device> 146 and <Device> 147 may be involved. However, in order to correctly answer this query, the <semanticDescriptor> 116 child resources of <Device> 111 should also be involved (assuming access control is not an issue here). Therefore, the final query result that is only based on <Device> 146 and <Device> 147 and their <semanticDescriptor> child resources may not be accurate since the semantic query is asking the result “over all the devices” (since <Device> 111 is missed).

The enhancement discussed below may include multiple approaches that may address query scope issues. In a first enhanced approach, SQI 121 may still specify any specific semantic query it wants, and on the RH-SLN 122, it may follow certain operation policies (as disclosed next) to determine the query scope in order to identify the involved <semanticDescriptor> child resources. First, both SQI 121 and RH-SLN 122 have the following agreements regarding how to decide the query scope, which includes the following three cases. In other words, the SQI 121 may understand in advance that the query may be only executed on an agreed query scope.

In case 1 of the first enhanced approach, SQI 121 may directly send its semantic query request targeted at <CSEBase> 210 resource such that all the <semanticDescriptor> child resources under <CSEBase> 210 resource may be checked, e.g., the query scope is the whole resource tree of the current RH-SLN 122 in this case. More generally, the solutions proposed in the previous sections may also be utilized, e.g., the <semanticDescriptor> child resources under <CSEBase> 210 may also have the “peerSemantics” attribute, which may link to other <semanticDescriptor> resources on another CSE.

In case 2 of the first enhanced approach, instead of sending the semantic query request targeted at <CSEBase> 210, a new resource called <queryPortal> is disclosed. Accordingly, SQI 121 may directly send its semantic query request targeted to this <queryPortal> resource. In particular, this <queryPortal> may have an attribute called “queryScope” that indicates its own query scope (the detailed descriptions of this new resource is discussed herein). Accordingly, all the semantic queries sent to this <queryPortal> resource will be executed in the query scope as indicated by its “queryScope” attribute of this <queryPortal> resource, which may be a URI and the corresponding query scope may be all the child resources under this URI. In addition, it is possible that a given RH-SLN 122 may include multiple <queryPortal> resources and each of them may have their own query scope. It is up to the SQIs to discover those <queryPortal> resources through e.g., normal resource discovery and select the one desired for the query to be executed.

In case 3 of the first enhanced approach, SQI 121 may directly send its semantic query request targeted at any resource URI (as specified by the “To” parameter), and it means that the query scope may be all <semanticDescriptor> child resources under this URI. Similarly, the solutions proposed in the previous sections may also be utilized, e.g., the <semanticDescriptor> child resources under the URI specified by the “To” parameter may also have a “peerSemantics” attribute to link to other <semanticDescriptor> resources that are in anywhere of the resource tree of this CSE. It should be noted that, although this case was studied with basic solution, this section provides additional changes that may make improvements. For example, since in this case SQI 122 may come up with any query it wants, certain inaccuracies may exist if the query scope used by RH-SLN 122 is not perfect to give the accurate query result. Therefore, here it is required that RH-SLN 122 may indicate the query result/quality summary when returning the query result to the SQI for its awareness.

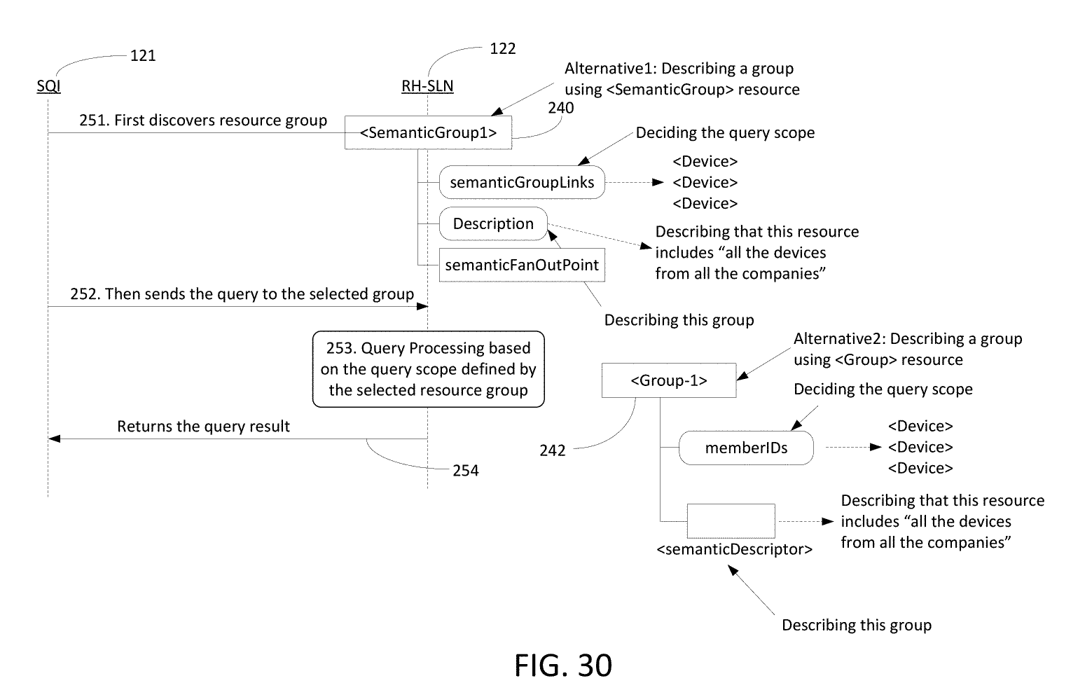

Regarding the semantic query processing stage, it is formally described as a procedure as shown in FIG. 29 (the detailed descriptions are illustrated by using the example shown in FIG. 28). At step 230, there is a precondition. Based on needs, SQI 121 may query some information on RH-SLN 122. Accordingly, SQI 121 formulates a SPARQL query statement to describe its question. For example, assuming SQI 121 intends to do a query as illustrated in scenario 4.

With reference to FIG. 29, at step 231, SQI 121 sends a request message to RH-SLN 122, in which it indicates that this request is related to a semantic query to be processed. In addition to the parameter as disclosed step 291 of FIG. 11, the message may include the new parameter Need_query_summary (nqs): The information indicates when RH-SLN 122 returns the query result to SQI 121, whether SQI 121 also wants related query result or quality summary information.

At step 232, upon receiving the semantic query from SQI 121, the query processing at RH-SLN 122 is conducted as follows. In a first action, if the “To” parameter is targeted to the <CSEBase> resource, it may handle this query processing according to details as introduced in Case 1 in order to identify the potential involved <semanticDescriptor> resources. Or, if the “To” parameter is targeted to a <queryPortal> resource, it may handle this query processing according to details as introduced in case 2 in order to identify the potential involved <semanticDescriptor> resources. Or, if the “To” parameter is targeted to any resource within the resource tree of RH-SLN 122, it may handle this query processing according to detailed as introduced in Case 3 in order to identify the potential involved <semanticDescriptor> resources. In a second action for step 232, for each of potential involved <semanticDescriptor> resource, RH-SLN 122 further evaluates whether the semantic query may be executed on it, based on certain access control policy. If so, such a resource will become a formal involved resource. In a third action for step 232, for each formal involved <semanticDescriptor> resource, the semantic query is executed on it. If there is a valid query result, this query result may be added to the final result set. In the meantime, the query processing on those formal involved resources may be conducted independently to each other. After the formal involved resources have been evaluated with the query, the final result set may contain the final query results, and it may be returned to the SQI 121.

At step 233, RH-SLN 122 may send back a response message to SQI 121, in which the query result is included by using the format as indicated by SQI 121. In addition to the parameter as proposed in the step 231 of FIG. 11, the message may include the following new parameter: query_summary (qs). The query_summary parameter may include the query result quality or summary information. For example, it may indicate which <semanticDescriptor> resources the query has been executed on. By utilizing this information, SQI 121 may evaluate whether the returned query result is desirable and sufficiently accurate or not. Other information may include query processing time cost, etc.

In the second enhanced approach, on RH-SLN 122 side, it may proactively aggregate some related resources together by using existing <group> and <semanticGroup> resources. Some features of the <group> and <semanticGroup> resources are as defined in existing TS-0001 and TR-0007. In summary, the semantic query process may be decoupled with the semantic descriptor collection. For example, without processing any semantic query, at the receiver side, it may proactively aggregate some related <semanticDescriptor> resources together by using existing <group> or <semanticGroup> resources. Accordingly, an SQI 121 may discover those resources first and then send semantic query to those resources for processing. In particular, in such an approach, the semantic query posed by the SQI 121 does not have to carry query scope related statements since the query scope has already been decided by the member resources of those <group> or <semanticGroup> resources.

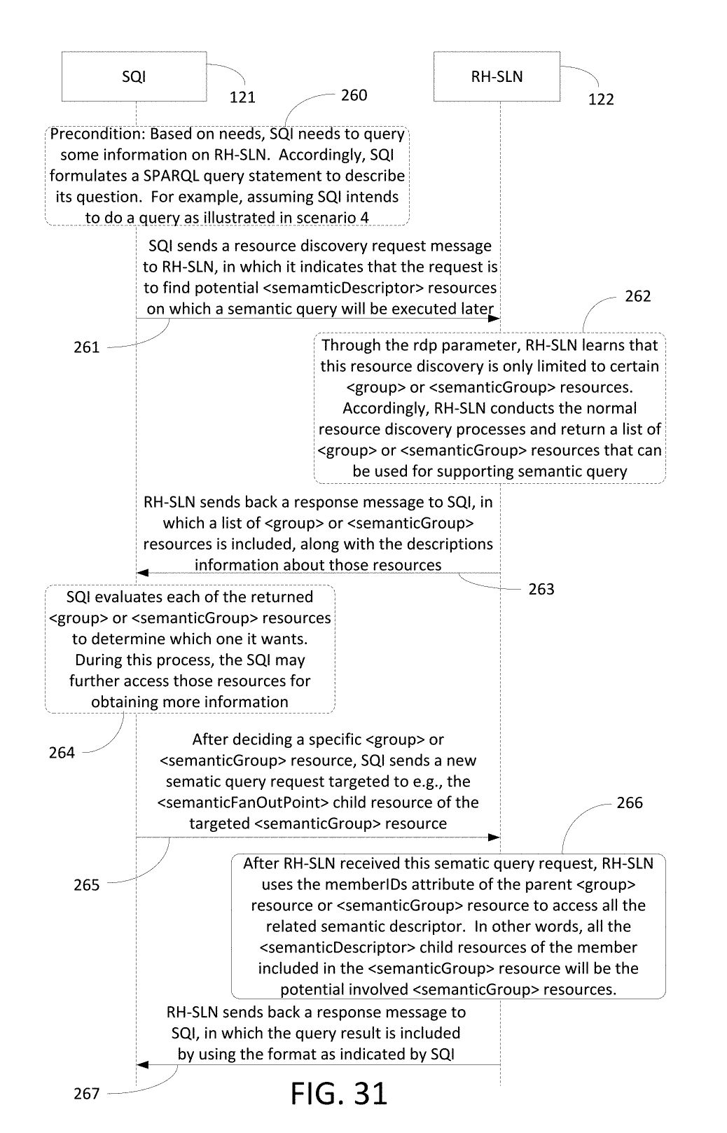

With continued reference to the second enhanced approach, for example, a <semanticGroup> resource (or a <group> resource) may be created at RH-SLN 122, which may include all the <semanticDescriptor> child resources of <Device> 111, <Device> 146, and <Device> 147 (by using e.g., the “semanticGroupLinks” attribute of the existing <semanticGroup> resource or the “memberIDs” attribute of the <group> resource). FIG. 30 gives two examples for those two cases. Accordingly, inside the <semanticGroup> resource, it may indicate what this group is about (as a general description, e.g., “all devices”) and also include all the references of devices. Accordingly, different from Approach 1 in which the SQI 121 needs to send the query like “querying the operation names of all the devices”, in Approach 2, SQI 121 may first discover a specific <semanticGroup> resource including all the devices of CompanyA and CompanyB as its members. By learning the general description of this <semanticGroup> resource, SQI 121 may understand that this <semanticGroup> resource has the references of all the devices. Then, SQI 121 may just send a query request “querying the operation names” without indicating a query scope (e.g., “of all the devices”) and such a query will be automatically applied to all the member resources of this <semanticGroup>, and all the involved <semanticDescriptor> child resources of <Device> 111, <Device> 146 and <Device> 147 may be checked. It may be seen in the second enhanced approach, the query scope is proactively decided at RH-SLN 122 side, and the SQI 121 knows the query scope or involved <semanticDescriptor> child resources before it sends out a semantic query. Accordingly, the query result is accurate in the second enhanced approach since both of SQI 121 and RH-SLN 122 have the same understanding on the query scope.

Below is more detail regarding how a semantic query may be processed in the second enhanced approach. At step 251, SQI 121 discovers a <semanticGroup> 240 or a <group> 242 resource. At step 252, SQI 121 may send a semantic query to this resource that may include a query request. In particular, a semantic query request may be mapped to a RETRIVE operation targeted at the <semanticFanOutPoint> child resource of this <group> or <semanticGroup> resources. The <semanticFanOutPoint> resource is a virtual resource because it does not have a representation. It is a child resource of the <group> resource with members of type <semanticDescriptor>. Whenever a semantic query request is sent to the <semanticFanOutPoint> resource, the host (e.g., RH-SLN 122 in this case) uses the memberIDs attribute of the parent <group> resource or <semanticGroup> resource to access all the related semantic descriptors. If there are semantic descriptors stored on other RH-SLNs, individual RETRIEVE requests are sent from RH-SLN 122 to each of the other RH-SLNs for retrieving the external semantic descriptors. Semantic descriptors are accessed based on the respective access control policies.

In particular, different from existing semantic discovery processing over those resources, in semantic query processing, once the involved <semanticDescriptor> resources are identified through <group> or <sematicGroup> resources, the query may be executed directly and individually on each of those involved <semanticDescriptor> resources. In the meantime, if an involved <semanticDescriptor> resource is on another RH-SLN that does not have the semantic query processing capability, the content of this involved <semanticDescriptor> resource may still be retrieved by the original RH-SLN receiving the semantic query request and hosting the <group> or <sematicGroup> resources, from where the query may be executed (but still individually). Finally, the final query result may be generated by combining all individual query results on each of involved <semanticDescriptor> resources (step 253).

FIG. 30 gives an example illustrating the above operating details. For example, at the RH-SLN 122 side, a <SemanticGroup-1> 240 resource may be created in which its semanticGroupLinks includes the references to all the devices, e.g., the <semanticDescriptor> (116, 148, 49) child resources of <Device> 111, <Device> 146 and <Device> 147 (or it may be just <Device> 111, <Device> 146, or <Device> 147 resources). A new “Description” attribute may be defined for this <SemanticGroup> resource as well in order to describe that this group includes all the devices from all the companies. The parameter may also include other beneficial information. For example, it can describe/indicate which kind of queries this <SemanticGroup> resources can support. This way may ease and help SQI 121 to discover proper <SemanticGroup> resource for sending semantic query later.

Alternatively, this group may also be represented by a <group> 242 resource. In particular, the <semanticDescriptor> resource of <Group-1> 242 may be used to describe what this resource group is about. Regarding the procedure, the SQI 121 may first discovers those <semanticGroup> 240 or <group> 242 resources (step 251). Once the appropriate one is selected, SQI 121 can send its semantic query to this selected <semanticGroup> 240 or <group> 242 resource (step 252), the query will be executed on the member resources as indicated by this selected <semanticGroup> 240 or <group> 242 resource (step 253). At step 254, the query result will be returned to SQI 121.

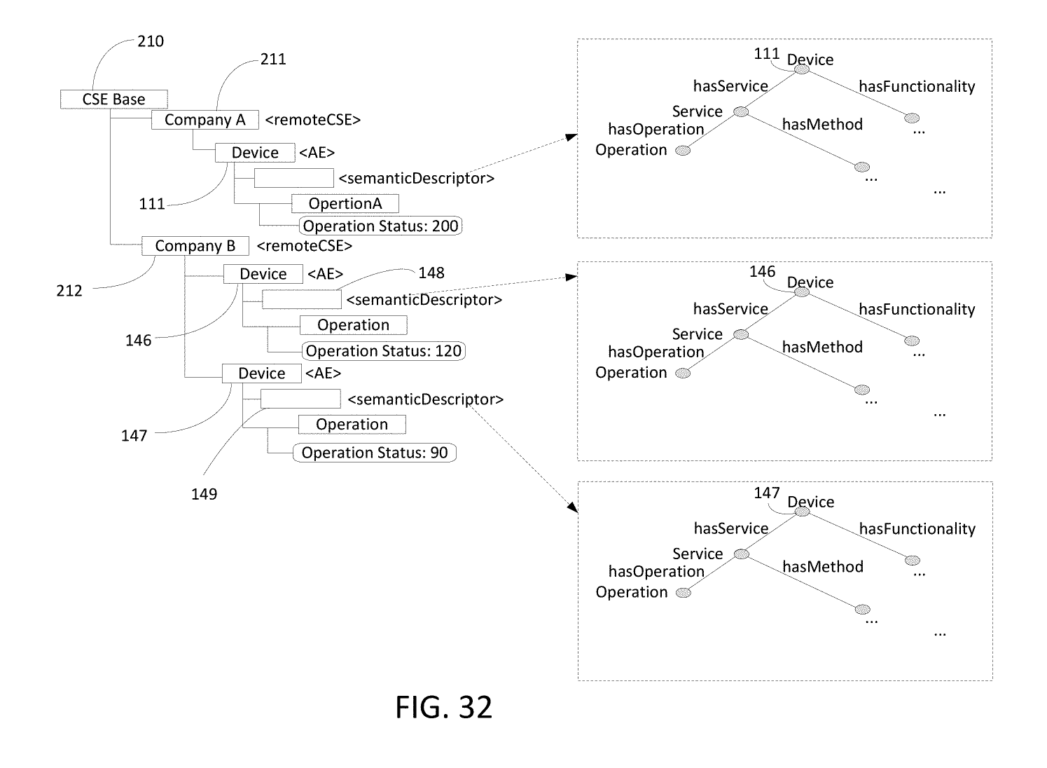

Regarding the semantic query processing stage, it is described as shown in FIG. 31). At step 261, SQI 121 sends a resource discovery request message to RH-SLN 122, in which it indicates that this request is to find potential <semanticDescriptor> resources on which a semantic query will be executed later. In this request, a new parameter resource_discovery_purpose (rdp) may indicate the purpose of this resource discovery request. The resource_discovery_purpose (rdp) information indicates SQI 121 is looking for <semanticDescriptor> resources for conducting a semantic query. At step 262, through the rdp parameter, RH-SLN 122 learns that this resource discovery is only limited to certain <group> 242 or <semanticGroup> 240 resources. Accordingly, RH-SLN 122 conducts the normal resource discovery processes and return a list of <group> 242 or <semanticGroup> 240 resources that can be used for supporting semantic query. At step 263, RH-SLN 122 sends back a response message to SQI 121, in which a list of <group> 242 or <semanticGroup> 240 resources is included, along with the descriptions information about those resources.

At step 264, SQI 121 evaluates each of the returned <group> 242 or <semanticGroup> 240 resources to determine which one it wants. During this process, the SQI 121 may further access those resources for obtaining more information. At step 265, after deciding a specific <group> 242 or <semanticGroup> 240 resource, SQI 121 sends a new semantic query request targeted to e.g., the <semanticFanOutPoint> child resource of the selected <semanticGroup> 240 resource. The new parameter query statement (QS), result format (RF), or need query summary (NQS) may be used. Query statement (qs) provides information that instructs storage of the query statement specified by SQI 121, which may be a SPARQL query statement. Alternatively, SQI 121 may also carry its query in the semantics filterCriteria. A result format (rf) provides information that instructs storage of how the query result should be represented, which may be plain text, JSON, or XML, format. Need_query_summary (nqs) provides information that indicates when RH-SLN 122 returns the query result to SQI 121, whether SQI 121 also wants related query result or quality summary information.

At step 266, after RH-SLN 122 received this semantic query request, RH-SLN 122 uses the memberIDs attribute of the parent <group> resource or <semanticGroup> 240 resource to access the related semantic descriptors. In other words, the <semanticDescriptor> child resources of the members included in the <semanticGroup> 240 resource may be the potential involved <semanticGroup> resources. In particular, the query processing may work as follows. In a first action, for each of potential involved <semanticDescriptor> resource, RH-SLN 122 further evaluate whether the semantic query may be executed on it based on certain access control policy. If so, such a resource may become a formal involved resource. In a second action, for a particular formal involved <semanticDescriptor> resource, it may a plurality cases. In a case 1, if it is hosted by RH-SLN 122, then the semantic query is directly executed on it. In a case 2, if it is hosted on another RH-SLN-2 (not shown), which also has semantic query processing capability, then RH-SLN 122 may send the semantic query to the other RH-SLN-2 in order to directly execute the semantic query on the other RH-SLN-2. In a case 3, if it is hosted on another RH-SLN-3 (not shown), which does not have semantic query processing capability, then RH-SLN 122 may retrieve all the content included in this involved <semanticDescriptor> resource from RH-SLN-3, and then execute the semantic query on RH-SLN 122 locally. After the formal involved resources have been evaluated with the query, the final result set may contain the final query results, and returned to the SQI 121. Alternatively, RH-SLN can also retrieve all the involved <semanticDescriptor> resources, which then form an integrated RDF data basis. Next, the semantic query statement will be executed on this integrated RDF data basis and semantic query result can be produced. At step 267, RH-SLN 122 sends back a response message to SQI 121, in which the query result is included by using the format as indicated by SQI 121. The quality summary information can also be returned if needed.

With reference to a fifth scenario, a semantic query request information that is not stored in the <semanticDescriptor> resource, e.g., some required information may not be represented as RDF triples but just stored in the normal resources. However, in the previously discussed second scenario, it is assumed that which <semanticDescriptor> resources are to be involved for executing the semantic query are already known based on e.g., the “To” parameter included in the semantic query request message. Scenario five discusses a situation in which a user needs information from some “targeted resources” (those target resources need to meet certain constraints), but identifying those targeted resources is not done in advance. The fifth scenario may be similar to a combination of the second scenario and the fourth scenario that was previously discussed. It is significant here that in this fifth scenario semantic query may be executed on any involved <semanticDescriptor>. A first step for the first scenario is to identify the “targeted resources” and then extract the needed information from those targeted resources. Therefore, it may be seen that although the user is still querying information, it does not directly rely on the semantic query processing, but may indirectly go through the existing semantic resource discovery processing.

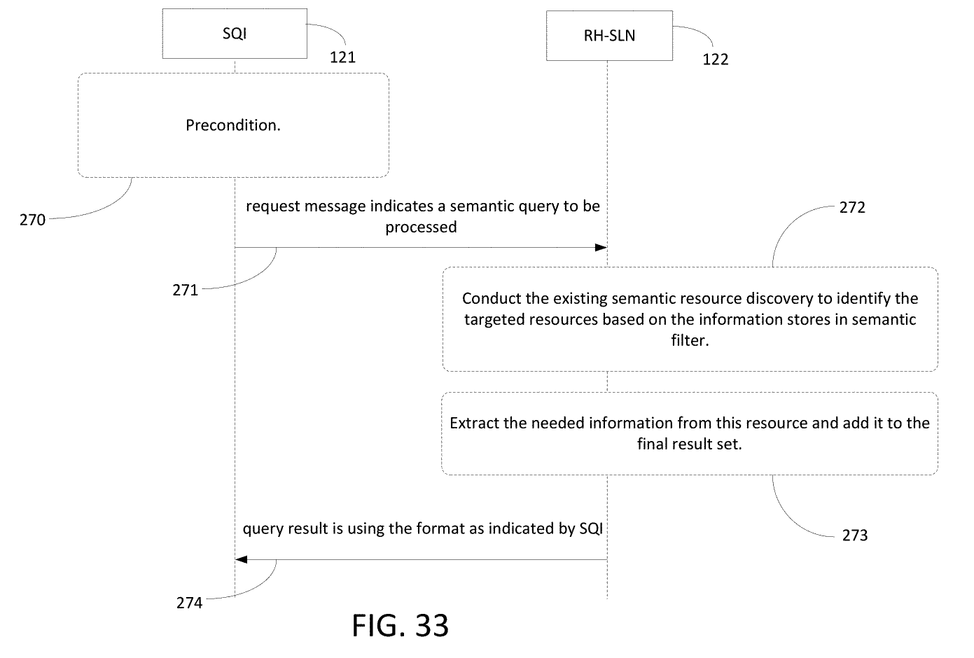

Below is further discussion with regard to the fifth scenario. FIG. 32 illustrates a partial resource tree structure in which <Device> 111, <Device> 146 and <Device> 147 represents three temperature devices, and each of them has a child resource <semanticDescriptor> storing their respective semantic descriptions. In the meantime, each of those three devices has an “OperationA”, and this operation has an attribute called “current operation status”. The intent of query description may be the following: “return me the current operation status of all the temperature devices that are from CompanyA and CompanyB.” Currently there is no solution as the one discussed herein that illustrates how to leverage the existing semantic resource discovery mechanism for further processing a semantic query.

There are multiple ways to leverage the existing semantic resource discovery process for processing a semantic query request. Herein are a few examples that leverage the existing semantic resource discovery process, such as scenario 5A and scenario 5B.

With reference to scenario 5A, SQI 121 still uses the existing semantic filter interface to specify its query. In the meantime, the semantic filter may specify how to identify the targeted resources. SQI 121 also indicates once the targeted resources are identified, which information needs to be extracted and returned. Similarly, once the RH-SLN 122 receives the request from SQI 121, it first identifies the targeted resources by using the constraints included in the semantic filter, which may be supported by existing semantic resource discovery. Once a resource is identified as a targeted resource, the RH-SLN 122 may further extract the information from this targeted resource.

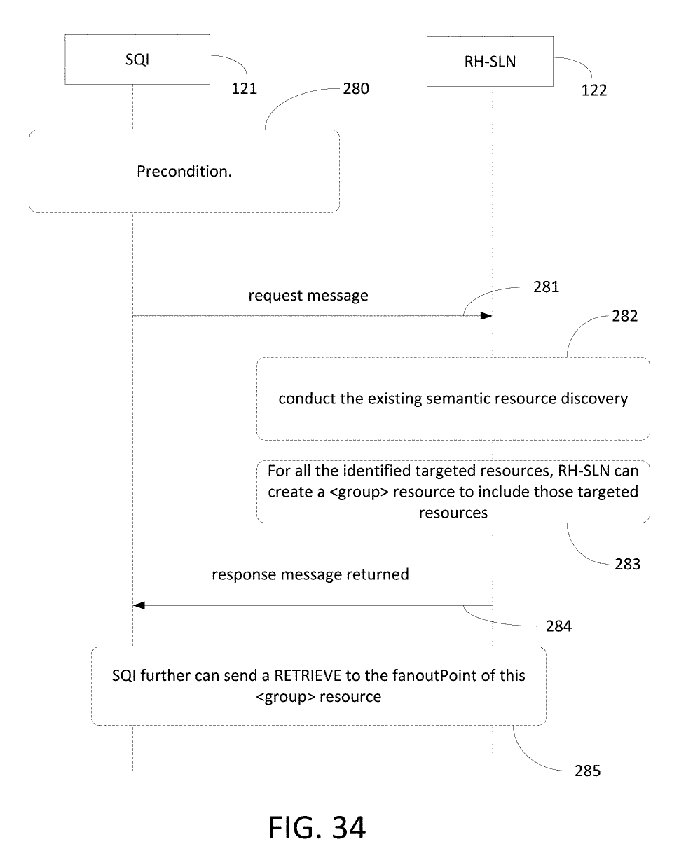

FIG. 33 illustrates an exemplary method in view of FIG. 32. At step 270, there may be a precondition. Precondition. Based on needs, SQI needs to query some information on RL-SLN. For example, assuming SQI intends to do a query as illustrated in scenario 5. At step 271, SQI 121 sends a request message to RH-SLN 122, which it indicates that this request is related to a semantic query to be processed. The semantic query of step 271 may include the following: semantic filter, needed information (NI), or result format (RF). An existing semantic filter may be utilized to specify how to identify the potential targeted resources through semantic resource discovery. For the example shown in the fifth scenario, the semantic filter may be written as follows (which is to find all the Operation A resources):

| | | |
|---|---|---|
| SELECT ?operation | | |
| WHERE { ?device | rdf:type | base:Device |
| ?device | rdf:is-from | CompanyA or CompanyB. |
| ?device | base:hasService | ?service |
| ?service | base:hasOperation | ?operation |
| ?operation | base:hasName | OperationA |
| } | | |

The needed information (NI) is information that should be extracted once a targeted resource is identified. Result format (RF) is information that instructs how to store the query result, which may be plain text, JSON or XML format.

Alternatively, SQI 121 may directly send a complete semantic query without using the existing semantic filter. If that is the case, the complete semantic query may be included in the previously-proposed Query Statement (QS) parameter as proposed in the first scenario. For the example shown in the fifth scenario associated with FIG. 32, the complete semantic query can be written as follows:

SELECT ?operationStatus

| | | |
|---|---|---|
| WHERE { ?device | rdf:type | base:Device |
| ?device | rdf:is-from | CompanyA or CompanyB. |
| ?device | base:hasService | ?service |
| ?service | base:hasOperation | ?operation |
| ?operation | base:hasName | OperationA |
| ?operation | base:hasStatus | operationStatus |
| } | | |

Note that although a complete semantic query may be submitted to RH-SLN 122. RH-SLN 122 may still use the existing semantic resource discovery for processing this query.

At step 272, upon receiving the semantic query from SQI 121, RH-SLN 122 conduct the existing semantic resource discovery to identify the targeted resources based on the information stored in semantic filter. In particular, even if SQI 121 sent a complete semantic query, the RH-SLN 122 may still first identify the related resources. For example, in the fifth scenario, the three <OperationA> resources may be identified as targeted resources. At step 273, for each targeted resource, RH-SLN 122 further extracts the needed information from this resource and adds it to the final result set. Once the information is extracted from the targeted resources, and it will be returned to the SQI 121. For example, in the fifth scenario, the operation status of the three <OperationA> resources will be extracted as semantic query result. At step 274, RH-SLN 122 sends back a response message to SQI 121, in which the query result is included by using the format as indicated by SQI 121. Alternatively, it is possible that the query result may be too large to be carried in a single response message, therefore, the RH-SLN 122 may create a new resource to store the query result, e.g., using the <request> resource. Then, RH-SLN 122 will not directly return the query result to SQI 121, but just the URI of the newly-created resource storing the query result. Accordingly, SQI 121 may choose to retrieve the query result by itself in a later time.

With reference to scenario 5B, SQI 121 may still use the existing semantic filter interface to specify its query. In the meantime, the semantic filter may specify how to identify the targeted resources. Different from scenario 5A, SQI 121 does not indicate which information needs to be extracted from the targeted resources. In other words, SQI 121 only relies on RH-SLN 122 for targeted resource discovery. Once the targeted resources are identified and returned to SQI 121, SQI 121 may further extract the information from those targeted resources by itself.

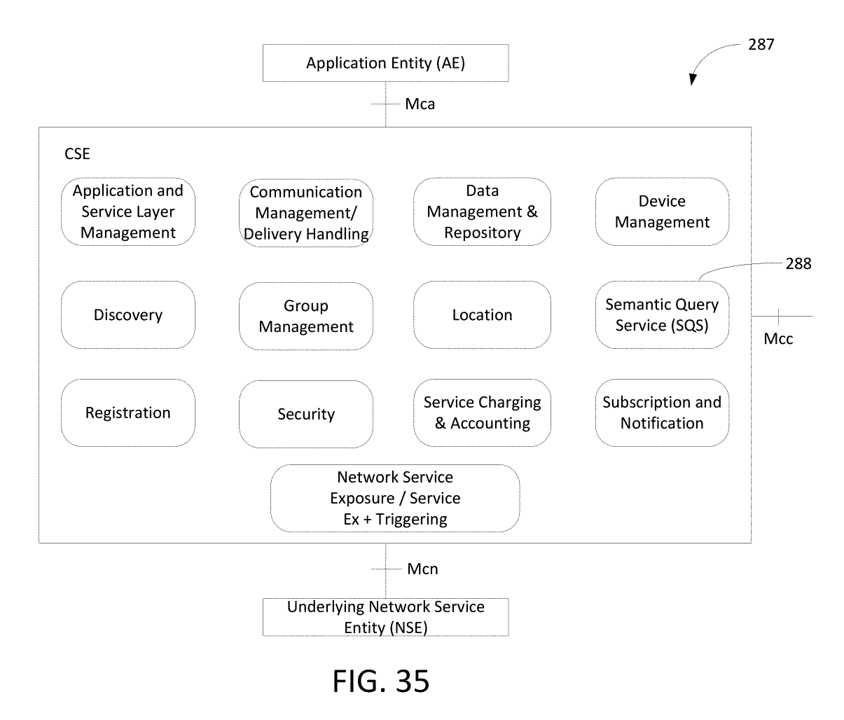

FIG. 43 illustrates exemplary steps. There may be a precondition at step 280. Based on needs, SQI needs to query some information on RH-SLN. For example, assuming SQI intends to do a query as illustrated in scenario 5. With reference to FIG. 34, at step 281, SQI 121 sends a request message to RH-SLN 122, in which it only requires semantic resource discovery. The semantic filter may be included in the request message. The semantic filter may specify how to identify the potential targeted resources through semantic resource discovery. For the example shown with regard to the fifth scenario, the semantic filter may be written as follows (which is to find all the OperationA resources):

| | | |
|---|---|---|
| SELECT ?operation | | |
| WHERE { ?device | rdf:type | base:Device |
| ?device | rdf:is-from | CompanyA or CompanyB. |
| ?device | base:hasService | ?service |
| ?service | base:hasOperation | ?operation |
| ?operation | base:hasName | OperationA |
| } | | |

With continued reference to FIG. 34, semantic query indicator (sq) indicates that SQI 121 is sending a semantic query to be executed, which means this request is not for semantic resource discovery, but for semantically querying or retrieving some derived information or knowledge based on some RDF triples. In an oneM2M embodiment, such sq parameter could be a new request parameter. Alternatively, the existing filterUsage of filterCriteria can also be used for realizing the effect of sq. For example, a new value can be defined for filterUsage such that as long as this new value appears, it means to trigger a semantic query operation.

At step 282, upon receiving the semantic query from SQI 121, RH-SLN 122 conducts the existing semantic resource discovery to identify the targeted resources based on the information stored in semantic filter. At step 283, for the identified targeted resource, RH-SLN 122 may create a <group> 242 resource to include those targeted resources. At step 284, RH-SLN 122 sends back a response message to SQI 121, in which the URI of the <group> resource is returned. At step 285, SQI 121 may send a RETRIEVE to the fanoutPoint of this <group> 242 resource to retrieve the needed value from discovered or targeted resources.

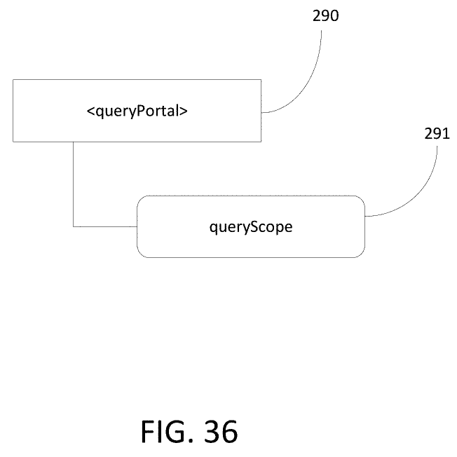

Semantic query CSF and logical entity examples are discussed below. oneM2M is currently in the process of defining capabilities supported by the oneM2M service layer. These capabilities are referred to as capability service functions (CSFs). The oneM2M service layer is referred to as a capability services entity (CSE) 287. Accordingly, the disclosed semantic query over distributed <semanticDescriptor> resources may be regarded as a new CSF 288 in service layer, as shown in FIG. 35. Alternatively, it may also be part of the existing semantic-related CSF defined in oneM2M TS-0001. The procedures as well as the new parameters disclosed herein mainly happen on mca and mcc/mcc′ reference point as illustrated in FIG. 35. Different types of M2M nodes may implement semantic query service, such as M2M Gateway, M2M Server, M2M Devices, etc. In particular, depending on the different hardware or software capacities for those nodes, the functionalities or capacities of semantic query services implemented by those nodes may also vary. In addition, in the context of oneM2M, the logical entity RH-SLN 122 may be embodied as a physical CSE. The logical entity SQI 121 may be embodied as an AE or a CSE.

Discussed below are attributes of normal oneM2M Resources. In scenario 2, one of our approaches was to add more RDF triples to represent the information that is originally not available in RDF format and stored in <semanticDescriptor> resource. For example, for the information Info-X coming from a normal Resource-A (e.g., the current temperature value 32 stored in the <reading> 113 resource), once new RDF triples are created to represent information Info-X, it may also be beneficial to indicate the event that which information in Resource-A was represented in RDF format. In order to do so, a new attributes “duplicatedAsRDF” is defined for Resource-A and the detailed description of “duplicatedAsRDF” is shown in Table 4. Note that Resource-A may be any existing or future resource types, such as <AE>, <CSE>, <container>, <contentInstance>, etc.

TABLE 4
New Attribute of Normal oneM2M Resource (e.g., Resource-A)

| Attributes of | |
|---|---|
| <accessControlPolicy> | Description |
| duplicatedAsRDF | This parameter is a flag which includes the |
| | attributes of Resource-A that their stored |
| | information in those attributes has already been |
| | represented as RDF format If during the creation |
| | of normal resources, the information stored in |
| | this resource is not being cloned to |
| | <semanticDescriptor> resources at the same time, |
| | it can do so in a later time and the |
| | duplicatedAsRDF can be set to “false”. It is also |
| | contemplated that a system-wide information |
| | clone service could be implemented, such that |
| | this service may check those resources in which |
| | the duplicatedAsRDF is still set to “false”. Then, |
| | this service will handle the information clone |
| | process and finally clone information into |
| | <semanticDescriptor> resources and set |
| | duplicatedAsRDF is set to “true” in the end. |

FIG. 42 illustrate an exemplary method associated with the second scenario and fourth scenario. At step 4201, RH-SLN 122 may obtain information associated with a sensor (e.g., <reading> 113>). Exemplary sensors may include accelerometer, biometrics sensors, or temperature sensors. At step 4202, RH-SLN 122 may incorporate the information associated with the sensor into a normal resource, such as a <contentInstanc>e. At step 4203, RH-SLN 122 may create a semanticDescriptor resource for the information, wherein the semanticDescriptor resource represents the information as a triple. At step 4204, RH-SLN 122 may flag that the normal resource information is duplicated as a triple.

New request parameters are discussed below. In oneM2M, SQI 121 may be embodied as an AE-1 and RH-SLN 122 may be embodied as a CSE-1. At a first step, the AE-1 sends a request to CSE-1, in which a semantic query is included. At a second step, upon receiving the request, CSE-1 conducts semantic query processing and works out query results. Note that this step is the most focused and innovative step in this disclosure, the query processing conducted in this step is different from case to case. At a third step, CSE-1 returns the query results back to AE-1. For oneM2M, when AE-1 sends a request to CSE-1, the request may be a oneM2M RETRIEVE request. Since there are certain differences for semantic query processing in the scenarios presented in herein, for example, new parameters may be carried in the RETRIEVE request and response messages.

Below is a summary of these parameters, which may be included in the oneM2M request or response messages. In scenario 1, the RETRIEVE message may include the following new parameters: SQ, SE, QS, or RF, among others. For scenario 2 and scenario 3, the RETRIEVE message may include the following: SQ, QS, or RF, among others. For the basic solution and the first approach of the enhanced solution associated with scenario 4, the RETRIEVE message may include SQ, QS, NQS, or RF, among others, while the response message may include QS. For the second approach of the enhanced solution associated with scenario 4, a RETRIEVE message may include RDP, another RETRIEVE message may include SQ, QS, NQS, or RF, among others, while the response message may include QS. For scenario 5A, the RETRIEVE message may include NI or SQ, among others.

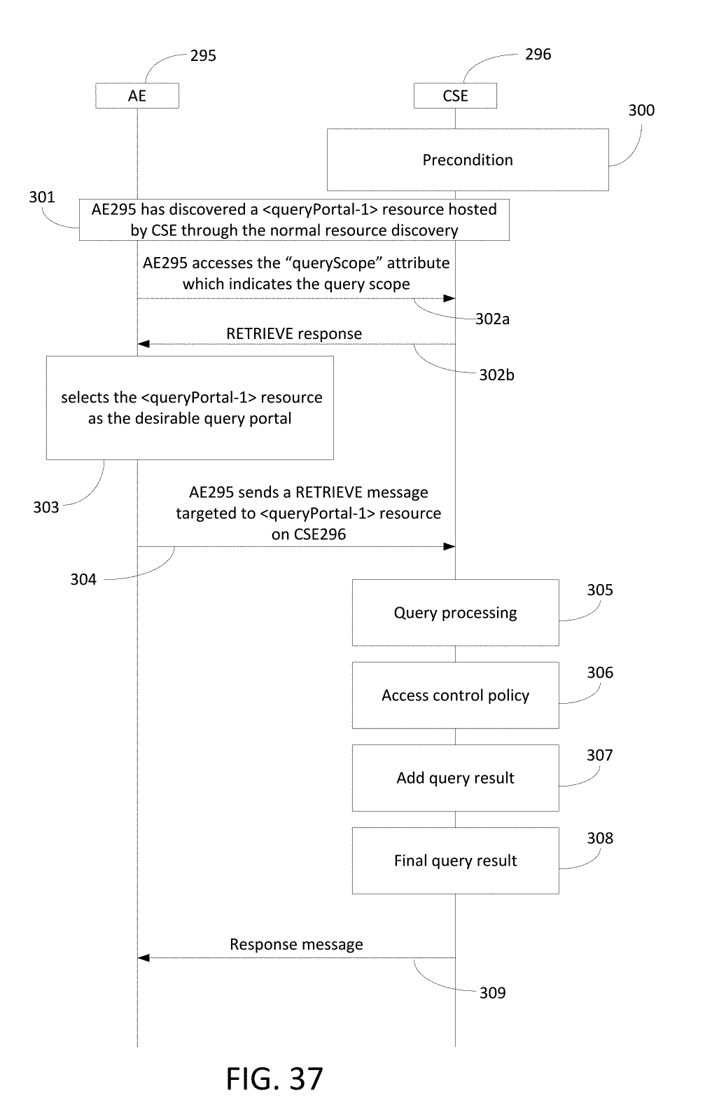

New Semantic Query Portal Resource <queryPortal>. For approach 1 of the enhanced solution for scenario 4, a new resource called <queryPortal> 290 is disclosed (see FIG. 36). The <queryPortal> 290 may have an attribute called “queryScope” 291 that indicates its own query scope. Accordingly, all the semantic queries sent to <queryPortal> 290 resource may be executed in the query scope as indicated by its “queryScope” 291 attribute of this resource. In addition, it is possible that a given CSE may include multiple <queryPortal> 290 resources and each of them has their own query scope 291. It is up a SQI (e.g., AE or CSE) to discover those <queryPortal> 290 resources, such as by normal resource discovery, and select the one desired for the query to be executed. The <queryPortal> 290 resources may be under <CSEBase> 210 for easy resource discovery. The <queryPortal> 290 resource may be configured through normal CRUD operations. For example, the hosting CSE may set up its own task for managing <queryPortal> 290 resources based on its knowledge and execute operations on the normal resources. As a result, once a semantic query is sent to a specific <queryPortal> resource, the involved <semanticDescriptor> resource as included in the queryScope 291 attribute may be retrieved. Then, the query may be executed on each of the <semanticDescriptor> resources and return a query result. The <queryPortal> 290 resource may include the attribute specified in Table 5.

TABLE 5
Attribute of <queryPortal> resource

| Attributes of | |
|---|---|
| <queryPortal> | Description |
| queryScope | This attributes can include a URI and the corresponding |
| | query scope will be all the child resources under this URI |
| | Alternatively, the “queryScope” attribute can also have |
| | multiple URIs, in that case, all the child resources under |
| | each of those URIs will be the potential query scope |
| | Another option, the “queryScope” attribute can also |
| | directly include URIs of a number of specific |
| | <semanticDescriptor> resources, and in this case, the |
| | “queryScope” attribute already indicates which are the |
| | involved <semanticDescriptor> resources In addition, the |
| | solutions proposed in the previous sections can also be |
| | utilized, e g , the <semanticDescriptor> child resources |
| | under the URI specified by the “queryScope” attribute |
| | may also have a “peerSemantics” attribute to link to |
| | other <semanticDescriptor> resources that are in |
| | anywhere of the resource tree of this CSE |

The Create/Retrieve/Update/Delete operations on a <queryPortal> resource are disclosed below. The Create <queryPortal> procedure may be used for creating a <queryPortal> resource as described in Table 6.

TABLE 6
<queryPortal> CREATE

| | |
|---|---|
| Associated | Mca, Mcc and Mcc'. |
| Reference Point | |
| Information in | All parameters defined in Table 8.1.2-3 in |
| Request message | oneM2M-TS-0001 oneM2M Functional |
| | Architecture-V2.9.0 (hereinafter [9]) apply |
| | with the specific details for: |
| | Content: The resource content provides the |
| | information about a <queryPortal> resource |
| | (e.g., attribute values). For example, the request |
| | message has the information to be assigned to the |
| | “query Scope” attribute. |
| Processing at | According to clause 10.1.1.1 in [9]. |
| Originator before | |
| sending Request | |
| Processing at | According to clause 10.1.1.1 in [9]. |
| Receiver | |
| Information in | All parameters defined in Table 8.1.3-1 in [9] |
| Response message | apply with the specific details for: |
| | Content: Address of the created <queryPortal> |
| | resource, according to clause 10.1.1.1 in [9]. |
| Processing at | According to clause 10.1.1.1 in [9]. |
| Originator after | |
| receiving Response | |
| Exceptions | According to clause 10.1.1.1 in [9]. |

This retrieve <queryPortal> procedure may be used for retrieving the attributes of a <queryPortal> resource as described in Table 7.

TABLE 7
<queryPortal> RETRIEVE

| | |
|---|---|
| Associated | Mca, Mcc and Mcc'. |
| Reference Point | |
| Information in | Parameters defined in Table 8.1.2-3 in [9] apply. In addition, since this |
| Request message | resource is to receive semantic query requests, the following new |
| | parameters as proposed in the previous sections will be included in the |
| | request message: |
| | Semantic query indicator (sq). |
| | Query statement (qs) |
| | Result format (rf) |
| | Need_query_summary (nqs) |
| Processing at | According to clause 10.1.2 in [9]. |
| Originator before | |
| sending Request | |
| Processing at | This retrieve operation typically corresponds to a semantic query to be |
| Receiver | conducted. Accordingly, the receiver needs to extract the semantic |
| | query from the request message and conduct the query processing based |
| | on the queryScope attribute of this <queryPortal> resource. |
| Information in | Parameters defined in Table 8.1.3-1 in [9] apply with the specific |
| Response message | details for: |
| | Content: the content normally includes the semantic query results. In |
| | addition, the following parameter may also be included: |
| | Third step: The response message may include the following new |
| | parameters: |
| | query_summary (qs) |
| Processing at | According to clause 10.1.2 in [9]. |
| Originator after | |
| receiving Response | |
| Exceptions | According to clause 10.1.2 in [9]. |
| | In addition: a timer has expired. The Receiver responds with an error. |

The update <queryPortal> procedure as described in Table 8 may be used to update an existing <queryPortal>, e.g. an update to its queryScope. The generic update procedure is described in clause 10.1.3 in [9].

TABLE 8
<queryPortal> UPDATE

| | |
|---|---|
| Associated | Mca, Mcc and Mcc'. |
| Reference Point | |
| Information in | Parameters defined in Table 8.1.2-3 in [9] |
| Request message | apply with the specific details for: |
| | Content: the new value of the queryScope |
| | attribute of the <queryPortal> resource |
| | should be included. |
| Processing at | According to clause 10.1.3 in [9]. |
| Originator before | |
| sending Request | |
| Processing at | According to clause 10.1.3 in [9]. |
| Receiver | |
| Information in | According to clause 10.1.3 in [9]. |
| Response message | |
| Processing at | According to clause 10.1.3 in [9]. |
| Originator after | |
| receiving Response | |
| Exceptions | According to clause 10.1.3 in [9]. |

The Delete <queryPortal> procedure as described in Table 9 shall be used to delete an existing <queryPortal>. The generic delete procedure is described in clause 10.1.4.1 in [9].

TABLE 9
<queryPortal> DELETE

| | |
|---|---|
| Associated | Mca, Mcc and Mcc'. |
| Reference Point | |
| Information in | All parameters defined in Table 8.1.2-3 in [9] apply. |
| Request message | |
| Processing at | According to clause 10.1.4.1 in [9]. |
| Originator before | |
| sending Request | |
| Processing at | According to clause 10.1.4.1 in [9]. |
| Receiver | |
| Information in | According to clause 10.1.4.1 in [9]. |
| Response message | |
| Processing at | According to clause 10.1.4.1 in [9]. |
| Originator after | |
| receiving Response | |
| Exceptions | According to clause 10.1.4.1 in [9]. |

Semantic Query Processing Procedure through <queryPortal> resource. This section gives a oneM2M example for the semantic query processing procedure through the <queryPortal> resource. FIG. 37 illustrates oneM2M-centric Procedure for Semantic Query Processing for scenario 4 through <queryPortal> resource. At step 300, <queryPortal-1> resource has been created by CSE 296 itself in order to create a query portal. At step 301, AE 295 discovers a <queryPortal-1> resource hosted by CSE 296 through the normal resource discovery. At step 302a and step 302b, AE 295 accesses the “queryScope” attribute which indicates the query scope. For example, the “queryScope” of <queryPortal-1> resource may include two URIs: <CSE>/<CompanyA> and <CSE>/<CompanyB>. At step 303, AE 295 intends to query information related to the devices from Company A and Company B, then it selects the <queryPortal-1> resource as the desirable query portal. The query of AE 295 may be: “Return me the working modes of the operations of all devices from Company A and Company B”.

At step 304, AE 295 sends a RETRIEVE message targeted to <queryPortal-1> resource on CSE 296 (as indicated in “To” parameter), the request message may include the following new parameter: SQ, QS, RF, or NQS, among others. At step 305, upon receiving the semantic query from AE 295, the query processing at CSE 296 is conducted. Since the “queryScope” of <queryPortal-1> resource includes two URIs: <CSE-1>/<CompanyA> and <CSE-1>/<CompanyB>, it may start to identify the <semanticDescriptor> resources undress those two URI. In particular, the <semanticDescriptor> child resources of <Device> 111, <Device> 146, <Device> 147 from all the companies will be identified as involved <semanticDescriptor> resources. See FIG. 26. At step 306, for each of potential involved <semanticDescriptor> resource, CSE 296 further evaluate whether the semantic query may be executed on it, based on certain access control policy. If so, such a resource may become a formal involved resource. At step, 307, for each formal involved <semanticDescriptor> resource, the semantic query is executed on it. If there is a valid query result, this query result may be added to the final result set. In the meantime, the query processing on those formal involved resources may be conducted independently to each other.

At step 308, after the formal involved resources have been evaluated with the query, the final result set may contain the final query results, and it may be returned to the AE 295. In the example of scenario 4, the working modes of the operations of <Device> 111, <Device> 146, <Device> 147 may be the final query result. At step, 30 CSE-1 sends back a response message to AE 295, in which the query result is included by using the format as indicated by AE 295 (as did in Step 4). In addition, the message may include the parameter QS. The parameter QS includes the query result quality or summary information. For example, it may indicate which <semanticDescriptor> resources the query has been executed on. By utilizing this information, the AE 295 may evaluate whether the returned query result is desirable and sufficiently accurate or not. Other information may include query processing time cost, etc.

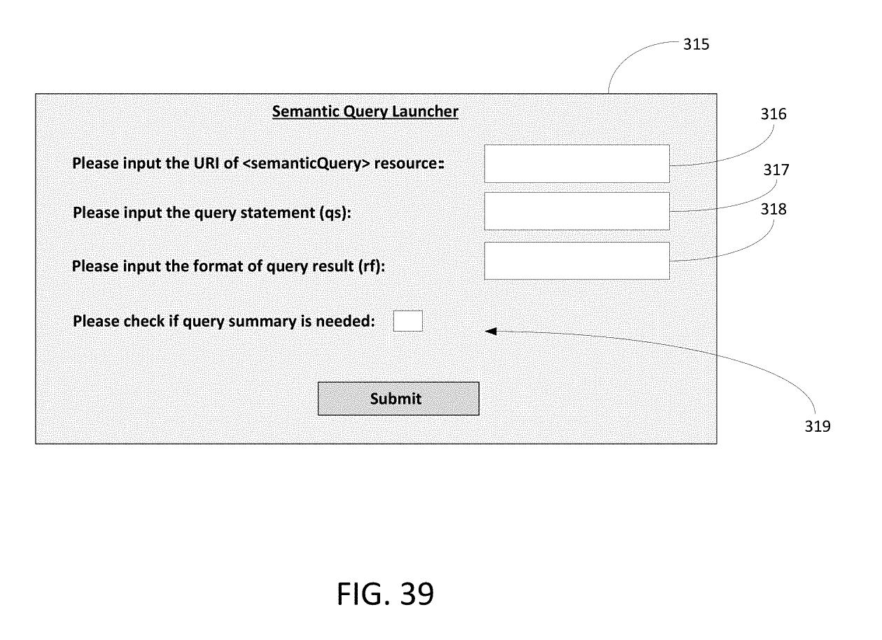

Discussed below are exemplary user interfaces for semantic query over distributed semantic descriptors, as discussed herein. FIG. 38 illustrates an exemplary user interface for semantic query scope check. Graphical user interface (GUI) 310 may be used for checking the query scope of a particular <semanticGroup> resource. By inputting in block 311 a URI of the <semanticGroup> resource to be checked, its member resources, e.g., the involved <semanticDescriptor> resources, may be shown. In particular, some of the member resources may not be on the same node as the received URI, accordingly. There is an option 312 to check the member resources on the node to which the URI input is targeted.

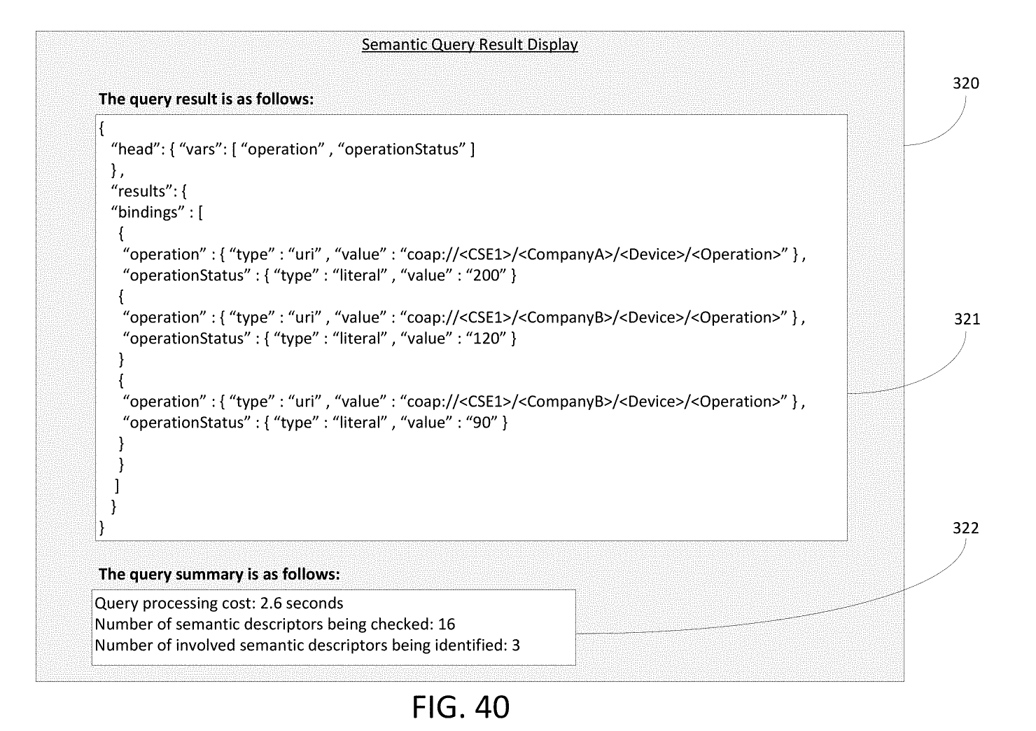

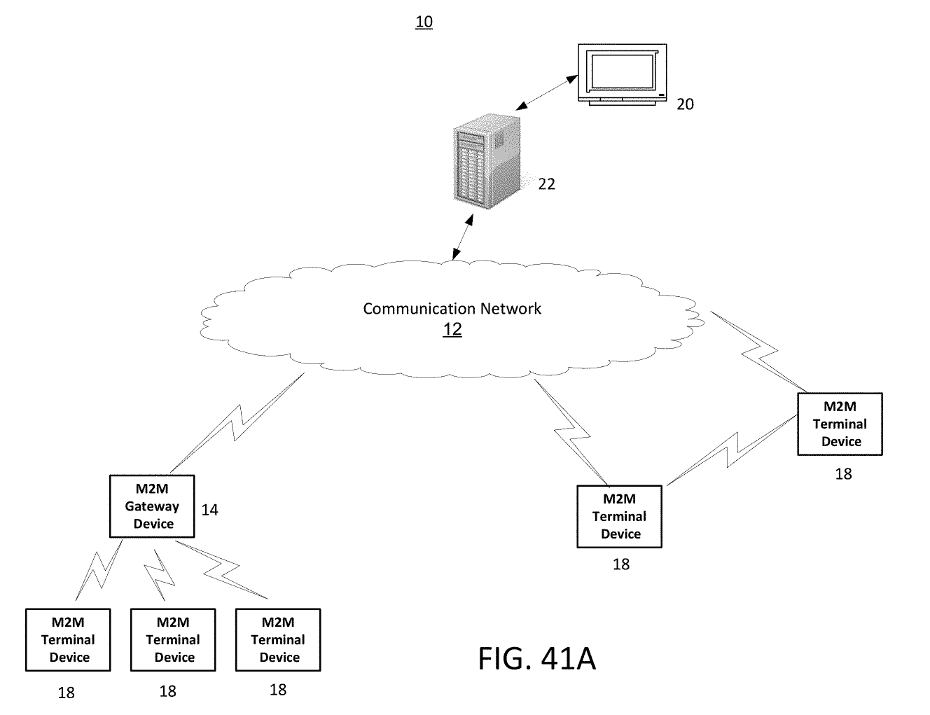

FIG. 39 illustrates exemplary user interface for semantic query launcher. GUI interface 320 may be used to launch a semantic query. As can be seen, the values of parameters may be received as disclosed herein. Block 316 may be used for <semanticQuery> resource, block 317 may be used for query statement input, block 318 may be used for format of query result, and there may be block 319 to indicate if query summary is needed. Accordingly, based on input, the semantic query message may be generated and sent for processing. FIG. 40 illustrates an exemplary user interface for semantic query result display. After semantic query result is returned, it may be shown on the semantic query result GUI 320 in block 321. Block 322 displays the query summary. In an example, the result shown in FIG. 40 is the operation status of Operation A of all the devices from Company A and Company B (as required by the user). In addition, the query summary information is also returned, in which it shows the query processing related information.

Without in any way unduly limiting the scope, interpretation, or application of the claims appearing herein, a technical effect of one or more of the examples disclosed herein is to provide adjustments to semantic query. Currently there is no existing solution for semantic query processing directly over distributed semantic descriptors (e.g., oneM2M <semanticDescriptor> resources). The methods and systems discussed herein enable semantic query as discussed herein. The disclosed subject matter allows for directly conducting query processing directly over a single resource (e.g., just using the information only from a single <semanticDescriptor>). The disclosed subject matter allows for semantic query using information not stored in semantic descriptors. The disclosed subject matter allows for semantic query distributed in different and unrelated semantic descriptors. This may include deciding the “query scope” for a semantic query. The disclosed subject matter allows for semantic query distributed in different but related semantic descriptors. This may include using the existing “resourceDescriptorLink” property is utilized such that related <semanticDescriptor> resources can be linked together in order to provide sufficient information needed by a semantic query. The disclosed subject matter allows for indirect querying information from targeted resources by leveraging existing semantic resource discovery. This may include procedures that leverage the semantic resource discovery mechanism to further retrieve information stored in resource tree that is queried and needed by a semantic query user.

FIG. 41A is a diagram of an example machine-to machine (M2M), Internet of Things (IoT), or Web of Things (WoT) communication system 10 in which one or more disclosed concepts associated with semantic query over distributed semantic descriptors may be implemented (e.g., FIG. 10-FIG. 39 and accompanying discussion). Generally, M2M technologies provide building blocks for the IoT/WoT, and any M2M device, M2M gateway or M2M service platform may be a component of the IoT/WoT as well as an IoT/WoT service layer, etc.

As shown in FIG. 41A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may comprise of multiple access networks that provides content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 41A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain includes M2M gateways 14 and terminal devices 18. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals via the communication network 12 or direct radio link. The M2M gateway device 14 allows wireless M2M devices (e.g. cellular and non-cellular) as well as fixed network M2M devices (e.g., PLC) to communicate either through operator networks, such as the communication network 12 or direct radio link. For example, the M2M devices 18 may collect data and send the data, via the communication network 12 or direct radio link, to an M2M application 20 or M2M devices 18. The M2M devices 18 may also receive data from the M2M application 20 or an M2M device 18. Further, data and signals may be sent to and received from the M2M application 20 via an M2M service layer 22, as described below. M2M devices 18 and gateways 14 may communicate via various networks including, cellular, WLAN, WPAN (e.g., Zigbee, 6LoWPAN, Bluetooth), direct radio link, and wireline for example.

Referring to FIG. 41B, the illustrated M2M service layer 22 (e.g., RH-SLN 122 or CSE 296 as described herein) in the field domain provides services for the M2M application 20 (e.g., AE 295 or SQI 121), M2M gateway devices 14, and M2M terminal devices 18, and the communication network 12. It will be understood that the M2M service layer 22 may communicate with any number of M2M applications, M2M gateway devices 14, M2M terminal devices 18, and communication networks 12 as desired. The M2M service layer 22 may be implemented by one or more servers, computers, or the like. The M2M service layer 22 provides service capabilities that apply to M2M terminal devices 18, M2M gateway devices 14 and M2M applications 20. The functions of the M2M service layer 22 may be implemented in a variety of ways, for example as a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateway devices 14 and M2M terminal devices 18 in the field domain. It will be understood that the M2M service layer 22′ may communicate with any number of M2M applications, M2M gateway devices and M2M terminal devices. The M2M service layer 22′ may interact with a service layer by a different service provider. The M2M service layer 22′ may be implemented by one or more servers, computers, virtual machines (e.g., cloud/compute/storage farms, etc.) or the like.

Referring also to FIG. 41B, the M2M service layer 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layer 22 and 22′ also enables M2M applications 20 and 20′ to communicate through various networks 12 and 12′ in connection with the services that the service layer 22 and 22′ provide.

In some examples, M2M applications 20 and 20′ may include desired applications that communicate using messages associated with semantic query over distributed semantic descriptors, as discussed herein. The M2M applications 20 and 20′ may include applications in various industries such as, without limitation, transportation, health and wellness, connected home, energy management, asset tracking, and security and surveillance. As mentioned above, the M2M service layer, running across the devices, gateways, and other servers of the system, supports functions such as, for example, data collection, device management, security, billing, location tracking/geofencing, device/service discovery, and legacy systems integration, and provides these functions as services to the M2M applications 20 and 20′.

The semantic query over distributed semantic descriptors of the present application may be implemented as part of a service layer. The service layer is a middleware layer that supports value-added service capabilities through a set of application programming interfaces (APIs) and underlying networking interfaces. An M2M entity (e.g., an M2M functional entity such as a device, gateway, or service/platform that is implemented on hardware) may provide an application or service. Both ETSI M2M and oneM2M use a service layer that may include the semantic query over distributed semantic descriptors of the present application. The oneM2M service layer supports a set of Common Service Functions (CSFs) (i.e., service capabilities). An instantiation of a set of one or more particular types of CSFs is referred to as a Common Services Entity (CSE), which can be hosted on different types of network nodes (e.g., infrastructure node, middle node, application-specific node). Further, the semantic query over distributed semantic descriptors of the present application can be implemented as part of an M2M network that uses a Service Oriented Architecture (SOA) or a resource-oriented architecture (ROA) to access services such as the semantic query over distributed semantic descriptors of the present application.

As discussed herein, the service layer may be a functional layer within a network service architecture. Service layers are typically situated above the application protocol layer such as HTTP, CoAP or MQTT and provide value added services to client applications. The service layer also provides an interface to core networks at a lower resource layer, such as for example, a control layer and transport/access layer. The service layer supports multiple categories of (service) capabilities or functionalities including a service definition, service runtime enablement, policy management, access control, and service clustering. Recently, several industry standards bodies, e.g., oneM2M, have been developing M2M service layers to address the challenges associated with the integration of M2M types of devices and applications into deployments such as the Internet/Web, cellular, enterprise, and home networks. A M2M service layer can provide applications r various devices with access to a collection of or a set of the above mentioned capabilities or functionalities, supported by the service layer, which can be referred to as a CSE or SCL. A few examples include but are not limited to security, charging, data management, device management, discovery, provisioning, and connectivity management which can be commonly used by various applications. These capabilities or functionalities are made available to such various applications via APIs which make use of message formats, resource structures and resource representations defined by the M2M service layer. The CSE or SCL is a functional entity that may be implemented by hardware or software and that provides (service) capabilities or functionalities exposed to various applications or devices (i.e., functional interfaces between such functional entities) in order for them to use such capabilities or functionalities.

FIG. 41C is a system diagram of an example M2M device 30, such as an M2M terminal device 18 (which may include AE 295 or SQI 121) or an M2M gateway device 14 (which may include one or more components of FIG. 30 or FIG. 20), for example. As shown in FIG. 41C, the M2M device 30 may include a processor 32, a transceiver 34, a transmit/receive element 36, a speaker/microphone 38, a keypad 40, a display/touchpad 42, non-removable memory 44, removable memory 46, a power source 48, a global positioning system (GPS) chipset 50, and other peripherals 52. It will be appreciated that the M2M device 30 may include any sub-combination of the foregoing elements while remaining consistent with the disclosed subject matter. M2M device 30 (e.g., AE 295, SQI 121, RH-SLN 122, CSE 296, and others) may be an exemplary implementation that performs the disclosed systems and methods for semantic query over distributed semantic descriptors.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 32 may perform signal coding, data processing, power control, input/output processing, or any other functionality that enables the M2M device 30 to operate in a wireless environment. The processor 32 may be coupled to the transceiver 34, which may be coupled to the transmit/receive element 36. While FIG. 41C depicts the processor 32 and the transceiver 34 as separate components, it will be appreciated that the processor 32 and the transceiver 34 may be integrated together in an electronic package or chip. The processor 32 may perform application-layer programs (e.g., browsers) or radio access-layer (RAN) programs or communications. The processor 32 may perform security operations such as authentication, security key agreement, or cryptographic operations, such as at the access-layer or application layer for example.

The transmit/receive element 36 may be configured to transmit signals to, or receive signals from, an M2M service platform 22. For example, the transmit/receive element 36 may be an antenna configured to transmit or receive RF signals. The transmit/receive element 36 may support various networks and air interfaces, such as WLAN, WPAN, cellular, and the like. In an example, the transmit/receive element 36 may be an emitter/detector configured to transmit or receive IR, UV, or visible light signals, for example. In yet another example, the transmit/receive element 36 may be configured to transmit and receive both RF and light signals. It will be appreciated that the transmit/receive element 36 may be configured to transmit or receive any combination of wireless or wired signals.

In addition, although the transmit/receive element 36 is depicted in FIG. 41C as a single element, the M2M device 30 may include any number of transmit/receive elements 36. More specifically, the M2M device 30 may employ MIMO technology. Thus, in an example, the M2M device 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the M2M device 30 may have multi-mode capabilities. Thus, the transceiver 34 may include multiple transceivers for enabling the M2M device 30 to communicate via multiple RATs, such as UTRA and IEEE 802.11, for example.

The processor 32 may access information from, and store data in, any type of suitable memory, such as the non-removable memory 44 or the removable memory 46. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the M2M device 30, such as on a server or a home computer. The processor 32 may be configured to control lighting patterns, images, or colors on the display or indicators 42 in response to whether the semantic query over distributed semantic descriptors in some of the examples described herein are successful or unsuccessful or otherwise indicate a status of semantic query over distributed semantic descriptors and associated components. The control lighting patterns, images, or colors on the display or indicators 42 may be reflective of the status of any of the method flows or components in the FIG.'s illustrated or discussed herein (e.g., FIG. 10-FIG. 37, etc). Disclosed herein are messages and procedures of semantic query over distributed semantic descriptors. The messages and procedures may be extended to provide interface/API for users to request semantic query over distributed semantic descriptors via an input source (e.g., speaker/microphone 38, keypad 40, or display/touchpad 42) and request, configure, or query distributed semantics information of resources, among other things that may be displayed on display 42.

The processor 32 may receive power from the power source 48, and may be configured to distribute or control the power to the other components in the M2M device 30. The power source 48 may be any suitable device for powering the M2M device 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the M2M device 30. It will be appreciated that the M2M device 30 may acquire location information by way of any suitable location-determination method while remaining consistent with information disclosed herein.

The processor 32 may further be coupled to other peripherals 52, which may include one or more software or hardware modules that provide additional features, functionality or wired or wireless connectivity. For example, the peripherals 52 may include various sensors such as an accelerometer, biometrics (e.g., fingerprint) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The transmit/receive elements 36 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The transmit/receive elements 36 may connect to other components, modules, or systems of such apparatuses or devices via one or more interconnect interfaces, such as an interconnect interface that may comprise one of the peripherals 52.

FIG. 41D is a block diagram of an exemplary computing system 90 on which, for example, the M2M service platform 22 of FIG. 41A and FIG. 41B may be implemented. Computing system 90 (e.g., M2M terminal device 18 or M2M gateway device 14) may comprise a computer or server and may be controlled primarily by computer readable instructions by whatever means such instructions are stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 or coprocessor 81 may receive, generate, and process data related to the disclosed systems and methods for semantic query over distributed semantic descriptors, such as queryScope, QS, NI, NQS, RF, and the like.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 can be read or changed by CPU 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may include peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include network adaptor 97 that may be used to connect computing system 90 to an external communications network, such as network 12 of FIG. 41A and FIG. 41B.

It is understood that any or all of the systems, methods and processes described herein may be embodied in the form of computer executable instructions (i.e., program code) stored on a computer-readable storage medium which instructions, when executed by a machine, such as a computer, server, M2M terminal device, M2M gateway device, or the like, perform or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not include signals per se. As evident from the herein description, storage media should be construed to be statutory subject matter. Computer readable storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

In describing preferred methods, systems, or apparatuses of the subject matter of the present disclosure—semantic query over distributed semantic descriptors—as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art (e.g., skipping steps, combining steps, or adding steps between exemplary methods disclosed herein). Such other examples are intended to be within the scope of the claims if they have structural elements that do not differ from the literal language of the claims, or if they include equivalent structural elements with insubstantial differences from the literal languages of the claims.

Methods, systems, and apparatuses, among other things, as described herein may provide means for semantic query over distributed semantic descriptors. A method, system, computer readable storage medium, or apparatus has means for determining that a semantic descriptor resource includes a class instance with a resource descriptor link annotation; and in response to the determining that the semantic descriptor resource includes a class instance with a resource descriptor link annotation to a first resource, adding the contents of the first resource that is linked by the resource descriptor link annotation to the semantic descriptor resource. The determining that the semantic descriptor resource includes the class instance with the resource descriptor link annotation may be responsive to a semantic query of the semantic descriptor resource. The contents of the first resource includes a triple or a resource description framework triple. The method, system, computer readable storage medium, or apparatus has means for subsequent to adding the contents of the first resource, executing a semantic query on the semantic descriptor resource. The method, system, computer readable storage medium, or apparatus has means for providing a result of the executed semantic query, wherein the result may be based on formatting instructions received in a request for the semantic query. The request for the semantic query precedes the determining that the semantic descriptor resource includes the class instance with the resource descriptor link annotation. The semantic descriptor resource may be a child resource. The method, system, computer readable storage medium, or apparatus has means for providing a result associated with the executed query to a display, wherein the result includes a query summary. The display may be connected with a mobile device. In some implementations, the semantic descriptor resource may be another resource instead. All combinations in this paragraph (including the removal or addition of steps) are contemplated in a manner that is consistent with the other portions of the detailed description.

Methods, systems, and apparatuses, among other things, as described herein may provide means for semantic query over distributed semantic descriptors. A method, system, computer readable storage medium, or apparatus has means for obtaining information from a sensor or otherwise associated with a sensor (e.g., readings from a sensor); providing the information associated with the sensor to a normal resource; creating a first semanticDescriptor resource for the information, wherein the first semanticDescriptor resource represents the information as a triple; and indicating in an attribute of the normal resource that the information is duplicated as a triple based on the creating the first semanticDescriptor resource. Although sensor is disclosed, it is contemplated that other devices (particularly M2M device) may be used. All combinations in this paragraph (including the removal or addition of steps) are contemplated in a manner that is consistent with the other portions of the detailed description.

Methods, systems, and apparatuses, among other things, as described herein may provide means for semantic query over distributed semantic descriptors. A method, system, computer readable storage medium, or apparatus has means for receiving a request message comprising a semantic query; in response to receiving the request message, executing the semantic query on a semantic descriptor resource; and halting the executing of the semantic query based on determining that the semantic descriptor resource comprises a node with a resource descriptor link annotation. The method, system, computer readable storage medium, or apparatus has means for conducting query processing directly over a single resource. The method, system, computer readable storage medium, or apparatus has means for using a “resourceDescriptorLink property such that related semantic descriptor resources are linked together in order to provide sufficient information needed by a semantic query. The method, system, computer readable storage medium, or apparatus has means for using a “query scope” for a semantic query to determine which semantic descriptors to use. The method, system, computer readable storage medium, or apparatus has means for using semantic resource discovery to retrieve information stored in a resource tree, in response to a semantic query. A method, system, computer readable storage medium, or apparatus has means for obtaining a data reading for a sensor; providing the data reading to a normal resource (e.g., constentInstance); and based on providing the data reading to the normal resource, creating a first semanticDescriptor resource for the normal resource, wherein the first semanticDescriptor resource represents the data reading as triples (e.g., RDF triples). The first semanticDescriptor resource may be linked with a second semanticDescriptor resource of another apparatus for obtaining updated data readings for the sensor. The first semanticDescriptor resource may be linked with the second semanticDescriptor resource via a uniform resource identifier. A method, system, computer readable storage medium, or apparatus has means for using semantic reasoning to obtain a unit of measurement of the data reading. There may be a flag that indicates stored information of an attribute has already been represented as RDF format. A method, system, computer readable storage medium, or apparatus has means for obtaining information associated with a sensor; providing the information associated with the sensor to a normal resource; and creating a first semanticDescriptor resource for the information. The first semanticDescriptor resource may represent the information as a triple. The information may be indicated as duplicated as a triple based on the creating of the first semanticDescriptor resource. A method, system, computer readable storage medium, or apparatus has means for obtaining request message comprising a semantic query; and halting the executing of the semantic query based on determining that the first semantic descriptor resource includes a first node of a plurality of nodes with a resource descriptor link annotation All combinations in this paragraph (including the removal or addition of steps) are contemplated in a manner that is consistent with the other portions of the detailed description.

What is claimed:

1. An apparatus for semantic query over distributed semantic descriptors, the apparatus comprising:
a processor; and
a memory coupled with the processor, the memory comprising executable instructions that when executed by the processor cause the processor to effectuate operations comprising:
obtaining information associated with a sensor;
providing the information associated with the sensor to a normal resource;
creating a first semanticDescriptor resource for the information, wherein the first semanticDescriptor resource represents the information as a triple; and
indicating in an attribute of the normal resource that the information is duplicated as a triple based on the creating the first semanticDescriptor resource.

2. The apparatus of claim 1, wherein the normal resource is a contentInstance resource.

3. The apparatus of claim 1, wherein the first semanticDescriptor resource is linked with a second semanticDescriptor resource of another apparatus for obtaining updated information from the sensor, wherein the information is measurements from the sensor.

4. The apparatus of claim 1, wherein the first semanticDescriptor resource is linked with a second semanticDescriptor resource of another apparatus for obtaining updated information from the sensor, wherein the first semanticDescriptor resource is linked with the second semanticDescriptor resource via a uniform resource identifier.

5. The apparatus of claim 1, the operations further comprising obtaining semantic metadata that indicates unit of measurement of the information.

6. The apparatus of claim 1, the operations further comprising using semantic reasoning to obtain a unit of measurement of the information.

7. The apparatus of claim 1, wherein the first semantic descriptor is a child resource of the normal resource.

8. A method comprising:
obtaining information associated with a sensor;
providing the information associated with the sensor to a normal resource;
creating a first semanticDescriptor resource for the information, wherein the first semanticDescriptor resource represents the information as a triple; and
indicating in an attribute of the normal resource that the information is duplicated as a triple based on the creating the first semanticDescriptor resource.

9. The method of claim 8, wherein the normal resource is a contentInstance resource.

10. The method of claim 8, wherein the first semanticDescriptor resource is linked with a second semanticDescriptor resource of another apparatus for obtaining updated information from the sensor, wherein the information is measurements from the sensor.

11. The method of claim 8, wherein the first semanticDescriptor resource is linked with a second semanticDescriptor resource of another apparatus for obtaining updated information from the sensor, wherein the first semanticDescriptor resource is linked with the second semanticDescriptor resource via a uniform resource identifier.

12. The method of claim 8, further comprising obtaining semantic metadata that indicates unit of measurement of the information.

13. The method of claim 8, further comprising using semantic reasoning to obtain a unit of measurement of the information.

14. The method of claim 8, wherein the first semantic descriptor is a child resource of the normal resource.

15. A computer readable storage medium storing computer executable instructions that when executed by a computing device cause said computing device to effectuate operations comprising:
obtaining information associated with a sensor;
providing the information associated with the sensor to a normal resource;
creating a first semanticDescriptor resource for the information, wherein the first semanticDescriptor resource represents the information as a triple; and
indicating in an attribute of the normal resource that the information is duplicated as a triple based on the creating the first semanticDescriptor resource.

16. The computer readable storage medium of claim 15, wherein the normal resource is a contentInstance resource.

17. The computer readable storage medium of claim 15, wherein the first semanticDescriptor resource is linked with a second semanticDescriptor resource of another apparatus for obtaining updated information from the sensor, wherein the first semanticDescriptor resource is linked with the second semanticDescriptor resource via a uniform resource identifier.

18. The computer readable storage medium of claim 15, the operations further comprising obtaining semantic metadata that indicates unit of measurement of the information.

19. The computer readable storage medium of claim 15, the operations further comprising using semantic reasoning to obtain a unit of measurement of the information.

20. The computer readable storage medium of claim 15, wherein the first semanticDescriptor resource is linked with a second semanticDescriptor resource of another apparatus for obtaining updated information from the sensor, wherein the information is measurements from the sensor.
